(19) United States
(12) Patent Application Publication
(10) Pub. No.: US 2025/0374281 A1
(43) Pub. Date: Dec. 4, 2025

(54) COMMUNICATION METHOD, COMMUNICATION APPARATUS, COMPUTER-READABLE STORAGE MEDIUM, AND PROGRAM PRODUCT

(71) Applicant: HUAWEI TECHNOLOGIES CO., LTD., Shenzhen (CN)

(72) Inventors: Mingyue Zhou, Shenzhen (CN); Lei Wang, Shenzhen (CN); Xiuqiang Xu, Shanghai (CN)

(73) Assignee: HUAWEI TECHNOLOGIES CO., LTD., Shenzhen (CN)

(21) Appl. No.: 19/261,212

(22) Filed: Jul. 7, 2025

Related U.S. Application Data
(63) Continuation of application No. PCT/CN2023/071415, filed on Jan. 9, 2023.

(51) Int. Cl. H04W 72/21; H04L 1/00; H04L 5/00

(52) U.S. Cl. CPC H04W 72/21; H04L 1/0003; H04L 5/0005

(57) ABSTRACT

The disclosed embodiments provide a communication method and apparatus, a computer-readable storage medium, and a computer program product. In the method, when a first communication apparatus determines that a first resource set used by a grant-based first terminal device for uplink transmission overlaps a second resource set used by a grant-free second terminal device for uplink transmission, the first communication apparatus determines a first transmission scheme in which the first terminal device performs the uplink transmission in an overlapping area, where the first transmission scheme includes at least one of a first channel coding scheme and a first multiple access scheme, and the overlapping area is determined by performing area division on a time-frequency resource of the first terminal device based on the overlapping. The first communication apparatus outputs the first transmission scheme.

### CROSS-REFERENCE TO RELATED APPLICATIONS

This application is a continuation of International Application No. PCT/CN2023/071415, filed on Jan. 9, 2023, the disclosure of which is hereby incorporated by reference in its entirety.

### TECHNICAL FIELD

The embodiments generally relate to the telecommunications field, and to a communication method, a communication apparatus, a non-transitory computer-readable storage medium, and a computer program product.

### BACKGROUND

A common transmission mechanism is as follows: when a user needs to occupy a physical layer channel resource for transmission of a service, the user sends a request to a base station, and the base station allocates the physical layer channel resource to the user for transmission based on the request, for example, a scheduling-based transmission mechanism. Another transmission mechanism is as follows: a base station side pre-configures a physical layer channel resource for a user and notifies the user, and when the user needs to perform transmission, the user only needs to perform transmission on the pre-configured physical layer channel resource, for example, a transmission mechanism based on scheduling-free pre-configuration. When channel resources are limited, if a resource collision occurs in the two transmission mechanisms, how to ensure that user transmission performance of the scheduling-based transmission mechanism is not affected is one of problems that need to be considered in a future network.

### SUMMARY

The embodiments provide a communication method, a communication apparatus, a non-transitory computer-readable storage medium, and a computer program product to control interference between terminal devices based on different transmission mechanisms, and reduce a performance loss of a grant-based terminal device.

According to a first aspect, a communication method is provided. The method may be performed by a first communication apparatus or may be performed by a chip used in the first communication apparatus. The following is described by using an example in which the method is performed by the first communication apparatus. In the method, when the first communication apparatus determines that a first resource set used by a grant-based first terminal device for uplink transmission overlaps a second resource set used by a grant-free second terminal device for uplink transmission, the first communication apparatus determines a first transmission scheme in which the first terminal device performs the uplink transmission in an overlapping area, where the first transmission scheme includes at least one of a first channel coding scheme and a first multiple access scheme, and the overlapping area is determined by performing area division on a time-frequency resource of the first terminal device based on the overlapping. The first communication apparatus outputs the first transmission scheme. In this manner, interference between terminal devices based on different transmission mechanisms can be controlled, and a performance loss of a grant-based terminal device can be reduced.

In some implementations, determining the first transmission scheme includes: the first communication apparatus divides a transport block of the first terminal device into a sub-code block based on the area division. The first communication apparatus determines a channel coding scheme and related parameters corresponding to the sub-code block in the overlapping area. This ensures that interference impact on the sub-code block is minimized.

In some implementations, the channel coding scheme and related parameters include a channel coding method and a channel coding parameter corresponding to the channel coding method. In this way, the channel coding method corresponding to the sub-code block is independent, so that interference from a grant-free terminal device to the grant-based terminal device is minimized.

In some implementations, determining the channel coding scheme and related parameters corresponding to the sub-code block in the overlapping area includes at least one of the following: the first communication apparatus reduces a code block length of the sub-code block in the overlapping area; the first communication apparatus lowers a code rate of the sub-code block in the overlapping area; and the first communication apparatus uses a channel coding method that matches a size of data that can be carried in the overlapping area. In this way, the interference from the grant-free terminal device to the grant-based terminal device is minimized in one or both of the following manners: modifying the channel coding method or modifying the channel coding parameter.

In some implementations, determining the first transmission scheme includes: the first communication apparatus determines a multiple access scheme and related parameters corresponding to the overlapping area. This ensures that interference impact on transmission is minimized.

In some implementations, determining the multiple access scheme and related parameters includes: based on the first terminal device and the second terminal device both using orthogonal multiple access in the overlapping area, the first communication apparatus adjusts a parameter of the multiple access scheme by performing at least one of the following operations: lowering a modulation order or limiting a transmission signal. In this way, the interference from the grant-free terminal device to the grant-based terminal device is minimized by modifying the multiple access parameter.

In some implementations, determining the multiple access scheme and related parameters includes: based on the first terminal device using orthogonal multiple access in the overlapping area and the second terminal device using non-orthogonal multiple access in the overlapping area, the first communication apparatus switches a multiple access scheme of the first terminal device to a non-orthogonal multiple access scheme. Alternatively, based on the first terminal device and the second terminal device both using non-orthogonal multiple access in the overlapping area, the first communication apparatus determines that the first terminal device keeps a non-orthogonal multiple access scheme. In the non-orthogonal multiple access scheme that is switched to or kept, the first communication apparatus indicates the first terminal device to select a parameter of the multiple access scheme based on interference from the second terminal device. In this way, the interference from the grant-free terminal device to the grant-based terminal device is minimized by adjusting the multiple access method.

In some implementations, the first transmission scheme further includes an interleaving scheme, and the interleaving scheme includes at least one of the following: interleaving data encoded by using the first channel coding scheme, where interleaved data corresponding to the same overlapping area includes encoded data corresponding to at least one sub-code block, and the sub-code block is obtained by dividing the transport block of the first terminal device; or interleaving data processed by using the first multiple access scheme, where interleaved data corresponding to the same overlapping area includes processed data corresponding to at least one sub-data sequence, and the sub-data sequence is obtained by dividing data processed by the first terminal device by using the first multiple access scheme. In this way, more time-frequency resources can be used to jointly resist the interference from the grant-free terminal device to the grant-based terminal device.

In some implementations, the first transmission scheme further includes a symbol-to-resource mapping rule corresponding to the overlapping area. In this way, the symbol-to-resource mapping rule may be independently set for the overlapping area, and a mapping form is more flexible. This helps reduce the performance loss of the grant-based terminal device.

In some implementations, determining the first transmission scheme includes: the first communication apparatus modifies an overall symbol-to-resource mapping rule to a local mapping rule, where the local mapping rule includes the mapping rule corresponding to the overlapping area, and the mapping rule corresponding to the overlapping area and a mapping rule corresponding to an area other than the overlapping area are independent of each other. A flexible mapping manner is provided, so that mapping rules of different areas can be independent of each other and a mapping rule in an area can be designed independently.

In some implementations, the overlapping area is determined by the first communication apparatus based on at least one of the following: a time-frequency position of the second resource set and a constraint related to a channel coding scheme; or a time-frequency position of the second resource set and a constraint related to a multiple access scheme. In this manner, the overlapping area is determined based on different transmission scheme adjustment manners. This helps minimize the interference from the grant-free terminal device to the grant-based terminal device.

In some implementations, the method further includes: the first communication apparatus determines that the first resource set also overlaps a third resource set of a grant-free third terminal device; and the first communication apparatus determines an overlapping area set in the first resource set based on the time-frequency position of the second resource set and a time-frequency position of the third resource set, where the overlapping area belongs to the overlapping area set. Overlapping areas may be divided for a grant-free terminal device group, to minimize the interference from the grant-free terminal device to the grant-based terminal device.

In some implementations, the method further includes: the first communication apparatus determines, when it is assumed that the overlapping does not exist, a second transmission scheme in which the first terminal device performs the uplink transmission, where the second transmission scheme includes at least one of a second channel coding scheme and a second multiple access scheme. The first communication apparatus outputs the second transmission scheme. In this way, a default transmission scheme may still be used for an area without overlap, to ensure that the interference from the grant-free terminal device to the grant-based terminal device is minimized.

In some implementations, the method further includes: before the first terminal device performs the uplink transmission, the first communication apparatus detects a change of a resource set that overlaps the first resource set. The first communication apparatus updates the first transmission scheme in which the first terminal device performs the uplink transmission in the overlapping area, where a changed resource set includes one of the following: an updated second resource set; the second resource set and the third resource set of the grant-free third terminal device that also overlaps the first resource set; and the third resource set and the updated second resource set. The first communication apparatus outputs an updated first transmission scheme. In this way, the transmission scheme may be refreshed in time based on a change status of the overlapping, to ensure minimum avoidance sacrifice of the grant-based terminal device.

In some implementations, updating the first transmission scheme includes: the first communication apparatus updates the overlapping area set in the first resource set based on a time-frequency position of the changed resource set, where the overlapping area belongs to the overlapping area set. The first communication apparatus determines the updated first transmission scheme based on an updated overlapping area set. It is ensured that the interference from the grant-free terminal device to the grant-based terminal device is minimized, and that the avoidance sacrifice of the grant-based terminal device is minimized.

In some implementations, the method further includes: before the first terminal device performs the uplink transmission, the first communication apparatus detects that the uplink transmission of the second terminal device is canceled. The first communication apparatus sends, to the first terminal device, indication information indicating that the first transmission scheme is invalid. When transmission of the grant-free terminal device is canceled, first precoding information may be refreshed in time, to ensure the minimum avoidance sacrifice of the grant-based terminal device.

In some implementations, the first communication apparatus outputs the first transmission scheme or the second transmission scheme by using signaling, and the signaling includes at least one of the following information: a length of the transport block of the first terminal device; a transmission scheme type, where the type indicates at least one of the following: different first transmission schemes or different second transmission schemes, where first transmission schemes indicated by different types have different content; a transmission scheme quantity; transmission scheme content; or a time-frequency resource position of the first terminal device. In this way, the first communication apparatus can flexibly indicate the transmission scheme by using the signaling, to control the interference between the terminal devices based on the different transmission mechanisms and reduce the performance loss of the grant-based terminal device.

According to a second aspect, a communication method is provided. For beneficial effects, refer at least to descriptions in the first aspect. Details are not described herein again. The method may be performed by a grant-based second communication apparatus, or may be performed by a chip used in the second communication apparatus. The following is described by using an example in which the method is performed by the second communication apparatus. In the method, the grant-based second communication apparatus receives indication information from a network device, where the indication information indicates a first transmission scheme in which the second communication apparatus performs uplink transmission in an overlapping area, the first transmission scheme is determined when a first resource set used for the uplink transmission of the second communication apparatus overlaps a second resource set used for uplink transmission of a grant-free third communication apparatus, the first transmission scheme includes at least one of a first channel coding scheme and a first multiple access scheme, and the overlapping area is determined by performing area division on a time-frequency resource of the second communication apparatus based on the overlapping. The second communication apparatus performs the uplink transmission in the overlapping area according to the first transmission scheme.

In some implementations, the first transmission scheme includes a channel coding scheme and related parameters corresponding to a sub-code block in the overlapping area, and the sub-code block is obtained by dividing a transport block of the second communication apparatus based on the area division.

In some implementations, the channel coding scheme and related parameters include a channel coding method and a channel coding parameter corresponding to the channel coding method.

In some implementations, the channel coding scheme and related parameters corresponding to the sub-code block in the overlapping area include at least one of the following: a new code block length that is of the sub-code block in the overlapping area and that is less than a preset code block length; a new code rate that is of the sub-code block in the overlapping area and that is lower than a preset code rate; or a channel coding method that matches a size of data that can be carried in the overlapping area.

In some implementations, the first transmission scheme includes a multiple access scheme and related parameters corresponding to the overlapping area.

In some implementations, the multiple access scheme and related parameters corresponding to the overlapping area are determined by performing at least one of the following operations: lowering a modulation order; limiting a transmission signal; or adjusting the multiple access scheme.

In some implementations, the first transmission scheme further includes an interleaving scheme, and the interleaving scheme includes one of the following: interleaving data encoded by using the first channel coding scheme, where interleaved data corresponding to the same overlapping area includes encoded data corresponding to at least one sub-code block, and the sub-code block is obtained by dividing the transport block of the second communication apparatus; or interleaving data processed by using the first multiple access scheme, where interleaved data corresponding to the same overlapping area includes processed data corresponding to at least one sub-data sequence, and the sub-data sequence is obtained by dividing data processed by the second communication apparatus by using the first multiple access scheme.

In some implementations, the first transmission scheme further includes a symbol-to-resource mapping rule corresponding to the overlapping area, and the mapping rule corresponding to the overlapping area and a mapping rule corresponding to an area other than the overlapping area are independent of each other.

In some implementations, the overlapping area is determined based on at least one of the following: a time-frequency position of the second resource set and a constraint related to a channel coding scheme; or a time-frequency position of the second resource set and a constraint related to a multiple access scheme.

In some implementations, the method further includes: before performing the uplink transmission, the second communication apparatus receives, from a network device, an updated first transmission scheme and indication information of a corresponding updated overlapping area. The second communication apparatus performs the uplink transmission in an updated overlapping area according to the updated first transmission scheme.

In some implementations, the method further includes: before performing the uplink transmission, the second communication apparatus receives, from the network device, indication information indicating that the first transmission scheme is invalid. The second communication apparatus performs the uplink transmission in the overlapping area by using a second transmission scheme, where the second transmission scheme is a transmission scheme that is determined by the network device when it is assumed that the overlapping does not exist and in which the second communication apparatus performs the uplink transmission.

In some implementations, the second communication apparatus receives the indication information from the network device by using signaling, and the signaling includes at least one of the following: a length of the transport block of the second communication apparatus; a transmission scheme type, where the type indicates at least one of the following: different first transmission schemes or different second transmission schemes, where first transmission schemes indicated by different types have different content; a transmission scheme quantity; transmission scheme content; or a time-frequency resource position of the second communication apparatus.

According to a third aspect, a first communication apparatus is provided. For beneficial effects, refer at least to the descriptions in the first aspect. Details are not described herein again. The first communication apparatus has a function of implementing behavior in the method instance in the first aspect. The function may be implemented by hardware, or may be implemented by executing corresponding software by hardware. The hardware or software includes one or more modules corresponding to the foregoing functions. In a possible design or implementation, the first communication apparatus includes: a processing unit, configured to: when it is determined that a first resource set used by a grant-based first terminal device for uplink transmission overlaps a second resource set used by a grant-free second terminal device for uplink transmission, determine a first transmission scheme in which the first terminal device performs the uplink transmission in an overlapping area, where the first transmission scheme includes at least one of a first channel coding scheme and a first multiple access scheme, and the overlapping area is determined by performing area division on a time-frequency resource of the first terminal device based on the overlapping; and an output unit, configured to output the first transmission scheme.

According to a fourth aspect, a second communication apparatus is provided. For beneficial effects, refer at least to the descriptions in the first aspect. Details are not described herein again. The apparatus has a function of implementing a behavior in the method instance in the second aspect. The function may be implemented by hardware, or may be implemented by executing corresponding software by hardware. The hardware or software includes one or more modules corresponding to the foregoing functions. In a possible design or implementation, the second communication apparatus includes: a receiving unit, configured to receive indication information from a network device, where the indication information indicates a first transmission scheme in which the grant-based second communication apparatus performs uplink transmission in an overlapping area, the first transmission scheme is determined when a first resource set used for the uplink transmission of the second communication apparatus overlaps a second resource set used for uplink transmission of a grant-free third communication apparatus, the first transmission scheme includes at least one of a first channel coding scheme and a first multiple access scheme, and the overlapping area is determined by performing area division on a time-frequency resource of the second communication apparatus based on the overlapping; and a transmission unit, configured to perform the uplink transmission in the overlapping area according to the first transmission scheme.

According to a fifth aspect, a communication apparatus is provided, and includes a processor and a memory storing instructions. When the instructions are executed by the processor, any method according to the first aspect and the implementations of the first aspect is performed.

According to a sixth aspect, a communication apparatus is provided, and includes a processor and a memory storing instructions. When the instructions are executed by the processor, any method according to the second aspect and the implementations of the second aspect is performed.

According to a seventh aspect, a non-transitory computer-readable storage medium is provided. The non-transitory computer-readable storage medium stores instructions, and when the instructions are executed, the method performed by the first communication apparatus or the second communication apparatus in the foregoing aspects is performed. According to an eighth aspect, a computer program product is provided. The computer program product includes instructions, and when the instructions are executed by an electronic device, the method performed by the first communication apparatus or the second communication apparatus in the foregoing aspects is performed.

According to a ninth aspect, a chip system is provided. The chip system includes a processor, configured to implement a function of the first communication apparatus or the second communication apparatus in the methods in the foregoing aspects. In a possible design or implementation, the chip system further includes a memory, configured to store program instructions and/or data. The chip system may include a chip, or may include a chip and another discrete component.

According to a tenth aspect, a communication system is provided, including a first communication apparatus configured to perform the method in the first aspect, or a second communication apparatus configured to perform the method in the second aspect and a third communication apparatus in the second aspect.

### BRIEF DESCRIPTION OF DRAWINGS

FIG. 1 is a diagram of a communication system according to an embodiment;

FIG. 2A is a diagram of an example procedure of a communication method according to an embodiment;

FIG. 2B is a diagram of another example procedure of a communication method according to an embodiment;

FIG. 2C is a diagram of still another example procedure of a communication method according to an embodiment;

FIG. 3 is a diagram of a communication procedure on which an embodiment is based;

FIG. 4 is a diagram of collision area division according to some embodiments;

FIG. 5 is a diagram of collision area division according to some other embodiments;

FIG. 6 is a diagram of collision area division according to still some other embodiments;

FIG. 7 is a block diagram of data sending according to some embodiments;

FIG. 8 is a block diagram of data sending according to some other embodiments;

FIG. 9 is a block diagram of data sending according to still some other embodiments;

FIG. 10 is a diagram of irregular symbol-to-resource mapping according to some embodiments;

FIG. 11 is a diagram of interleaving-based transmission scheme adjustment according to some embodiments;

FIG. 12 is a diagram of a communication procedure according to some embodiments;

FIG. 13 is a diagram of interleaving-based transmission scheme adjustment according to some other embodiments;

FIG. 14 is a diagram of interference distribution before and after interleaving according to some embodiments;

FIG. 15 is a diagram of a procedure implemented at a first communication apparatus according to some embodiments;

FIG. 16 is a diagram of a procedure implemented at a grant-based second communication apparatus according to some embodiments;

FIG. 17 is a diagram of main composition of an example device in a possible implementation according to an embodiment; and

FIG. 18 is a simplified block diagram of an example device in a possible implementation according to an embodiment.

### DETAILED DESCRIPTION OF EMBODIMENTS

The following describes embodiments in more detail with reference to the accompanying drawings. Although some embodiments are shown in the accompanying drawings, it should be understood that the embodiments can be implemented in various forms, and should not be construed as being limited to embodiments described herein, and instead, these embodiments are provided for a more thorough and complete understanding thereof. It should be understood that the accompanying drawings and embodiments are merely used as examples and are not intended to limit the scope of the embodiments.

In the descriptions of embodiments, the term “including” and similar terms thereof shall be understood as non-exclusive inclusions, that is, “including, but not limited to”. The term “based on” should be understood as “at least partially based on”. The term “one embodiment” or “this embodiment” should be understood as “at least one embodiment”. The terms “first”, “second”, and the like may indicate different objects or a same object. Other explicit and implicit definitions may also be included below.

Embodiments may be implemented according to any proper communication protocol, including, but not limited to, cellular communication protocols such as 4th generation (4G), 5th generation (5G), and future (for example, 6th generation (6G)) communication protocols, a wireless local area network communication protocol like the institute of electrical and electronics engineers (IEEE) 802.11 (for example, Wi-Fi7 and Wi-Fi8), and/or any other protocol currently known or developed in the future.

Solutions in embodiments are applied to a communication system that complies with any proper communication protocol, for example, a general packet radio service (GPRS) system, a global system for mobile communications (GSM), an enhanced data rate for GSM evolution (EDGE) system, a universal mobile telecommunications system (UMTS), a long term evolution (LTE) system, a wideband code division multiple access (WCDMA) system, a code division multiple access 2000 (CDMA2000) system, a time division-synchronous code division multiple access (TD-SCDMA) system, a frequency division duplex (FDD) system, a time division duplex (TDD) system, a 5th generation (5G) system (for example, a new radio (NR) system), and a future communication system (for example, a 6th generation (6G) system). For example, the solutions in embodiments may be used for any network in which a pre-scheduling mode exists.

For the purpose of illustration, the following describes embodiments in the context of a 5G communication system in 3GPP. However, it should be understood that embodiments are not limited to the communication system, but may be applied to any communication system having a similar problem, for example, a wireless local area network (WLAN), a wired communication system, or another communication system developed in the future.

The term “terminal” or “terminal device” used in the embodiments refers to any terminal device that can perform wired or wireless communication with a network device or any terminal devices that can perform wired or wireless communication with each other. The terminal device may be sometimes referred to as user equipment (UE). The terminal device may be any type of mobile terminal, fixed terminal, or portable terminal. The terminal device may be various wireless communication devices that have a wireless communication function. With emergence of an internet of things (IoT) technology, more devices that previously have no communication function, for example without limitation to, a household appliance, a transportation tool, a tool device, a service device, and a service facility, start to obtain a wireless communication function by being configured with a wireless communication unit, to access a wireless communication network, and accept remote control. Such a device has the wireless communication function because the device is configured with the wireless communication unit, and therefore also belongs to a scope of wireless communication devices. For example, the terminal device may include a mobile cellular phone, a cordless phone, a mobile terminal (MT), a mobile station, a mobile device, a wireless terminal, a handheld device, a client, a subscription station, a portable subscription station, an internet node, a communicator, a desktop computer, a laptop computer, a notebook computer, a tablet computer, a personal communication system device, a personal navigation device, a personal digital assistant (PDA), a wireless data card, a wireless modulator demodulator (modem), a positioning device, a radio broadcast receiver, an e-book device, a game device, an internet of things (IoT) device, a vehicle-mounted device, a flight vehicle, a virtual reality (VR) device, an augmented reality (AR) device, a wearable device (for example, a smart watch), a terminal device in a 5G network or any terminal device in an evolved public land mobile network (PLMN), another device that can be used for communication, or any combination thereof. This is not limited.

The term “network node” or “network device” used in the embodiments is an entity or a node that may be configured to communicate with a terminal device, for example, may be an access network device. The access network device may be an apparatus that is deployed in a radio access network and that provides a wireless communication function for a mobile terminal. For example, the access network device may be a radio access network (RAN) network device. The access network device may include various types of base stations. The base station is configured to provide a wireless access service for the terminal device. For example, each base station corresponds to a service coverage area, and a terminal device entering the area may communicate with the base station by using a radio signal, to receive a radio access service provided by the base station. The service coverage areas of the base stations may overlap, and a terminal device in an overlapping area may receive radio signals from multiple base stations. Therefore, the multiple base stations may simultaneously provide services for the terminal device. Based on a size of the provided service coverage area, the access network device may include a macro base station providing a macro cell, a micro base station providing a micro cell, a pico base station providing a pico cell, and a femto base station providing a femto cell. In addition, the access network device may further include various forms of relay stations, access points, remote radio units (RRU), radio frequency heads (RH), remote radio heads (RRH), and the like. In systems using different radio access technologies, the access network device may have different names. For example, the access network device is referred to as an evolved NodeB (eNB or eNodeB) in a long term evolution (LTE) system network, is referred to as a NodeB (NB) in a 3G network, and may be referred to as a gNodeB (gNB) or an NR NodeB (NR NB) in the 5G network. In some scenarios, the access network device may include a central unit (CU) and/or a distributed unit (DU). The CU and DU may be deployed in different places. For example, the DU is remotely deployed in a high-traffic area, and the CU is deployed in a central equipment room. Alternatively, the CU and the DU may be deployed in a same equipment room. The CU and the DU may alternatively be different components of one rack. For ease of description, in subsequent embodiments, the foregoing apparatuses that provide a wireless communication function for the mobile terminal are collectively referred to as the network device. The apparatus may alternatively be a chip or a module that is in the mobile terminal or the access network device and that implements a related wireless communication function. This is not limited.

Because overall channel resources are limited, allocated physical layer channel resources of a first transmission mechanism (for example, GB) and a second transmission mechanism (for example, GF) may overlap, and the overlapping is also referred to as a collision. In other words, a user equipment (for example, a GB user equipment) based on the first transmission mechanism and a user equipment (for example, a GF user equipment) based on the second transmission mechanism simultaneously perform data transmission on one channel resource.

The Grant Base (referred to as GB for short) transmission mechanism is a mechanism in which when a user equipment needs to perform transmission of a service by occupying a physical layer channel resource for transmission, the user equipment sends a request to a base station. The base station allocates, based on the request, the physical layer channel resource to the user equipment for transmission. NR is used as an example. A physical layer channel resource allocated by a network side to the GB user equipment is a time domain-frequency domain two-dimensional resource that is based on OFDM/DFT-S-OFDM. The Grant Free (configured without grant, referred to as GF for short) transmission mechanism is a mechanism in which a base station side pre-configures a physical layer channel resource for a user equipment and notifies the user equipment, and when the user equipment needs to perform transmission, the user equipment needs to perform transmission only on the pre-configured physical layer channel resource. This can reduce transmission latency of the user equipment and reduce signaling overheads, and is suitable for a short-latency service and a service with a periodic attribute. Configured Grant transmission mechanisms (Configured Grant Type 1 and Configured Grant Type 2) in an NR protocol belong to this type of transmission scheme. Because the overall channel resources are limited, the allocated physical layer channel resources of the GF and the GB may overlap, and the overlapping is also referred to as the collision. In other words, the GF user equipment and the GB user equipment simultaneously perform data transmission on one channel resource. How to ensure that the transmission performance of the GB user is not affected when the GF/GB resource collision occurs is one of problems that need to be considered in a future network. An overlapping channel resource may be defined as a collision area, and a non-overlapping channel resource may be defined as a non-collision area.

A collision resolution solution is that the base station (gNB) allocates a time-frequency resource to a Grant Base UE 1 user equipment for bearing an uplink PUSCH channel of the Grant Base UE 1, and the base station also periodically allocates a time-frequency resource to a Grant Free UE 2 for sending uplink service data by the Grant Free UE 2. When the UE 2 performs sending, a resource collision occurs between the UE 2 and the UE 1 in some time-frequency areas. To ensure transmission of a target user, a solution in which transmit power of the target user is increased, and transmit power of a non-target user equipment is reduced is used. If the target user equipment is the GF user equipment, the GF user equipment performs transmission at high power, and the GB user equipment performs transmission at low power. If the target user equipment is the GB user equipment, the GB user equipment performs transmission at high power, and the GF user equipment performs transmission at low power. In this solution, power between users is adjusted. This reduces interference to the target user equipment, but cannot completely cancel the interference. A powerful receiver solution, like IC, is needed on the base station side to reduce the interference to the target user. For the non-target user equipment, because the transmit power is reduced, an SINR on a receiving side is reduced, and a performance loss of the non-target user equipment is greater.

Another collision resolution solution is that when a resource collision between GF and GB occurs, the base station side (gNB) delivers new signaling to the GB user equipment, to make the GB user equipment cancel signal transmission on a collision resource, in other words, active avoidance of the GB user equipment is used to ensure transmission reliability of the GF user equipment. In this case, the gNB can attempt to demodulate a GB service on a non-preempted resource, and if a CRC is correct, GB transmission succeeds. However, in this solution, transmission cancellation is beneficial to the target user equipment (the GF user equipment), but is unbeneficial to the non-target user equipment (the GB device). In addition, because the resource of the GF user equipment is pre-configured, and does not necessarily match a sending requirement of the GF user equipment, when the GF resource for sending takes effect, the GF user equipment performs no data transmission. In this case, the active avoidance sacrifice of the GB user equipment is invalid.

In embodiments, a problem of a resource collision (for example, the resource collision between the GB and the GF) between terminal devices based on different transmission mechanisms can be resolved, and problems, caused according to the foregoing solution, such as that the interference between the GF user equipment and the GB user equipment cannot be effectively controlled, and invalid sacrifice of the resources of the GF user equipment and GB user equipment can be resolved. To make the objectives, solutions, and advantages clearer, the following further describes the embodiments in detail with reference to the accompanying drawings. Specific operation methods, function descriptions, and the like in method embodiments may also be applied to apparatus embodiments or system embodiments.

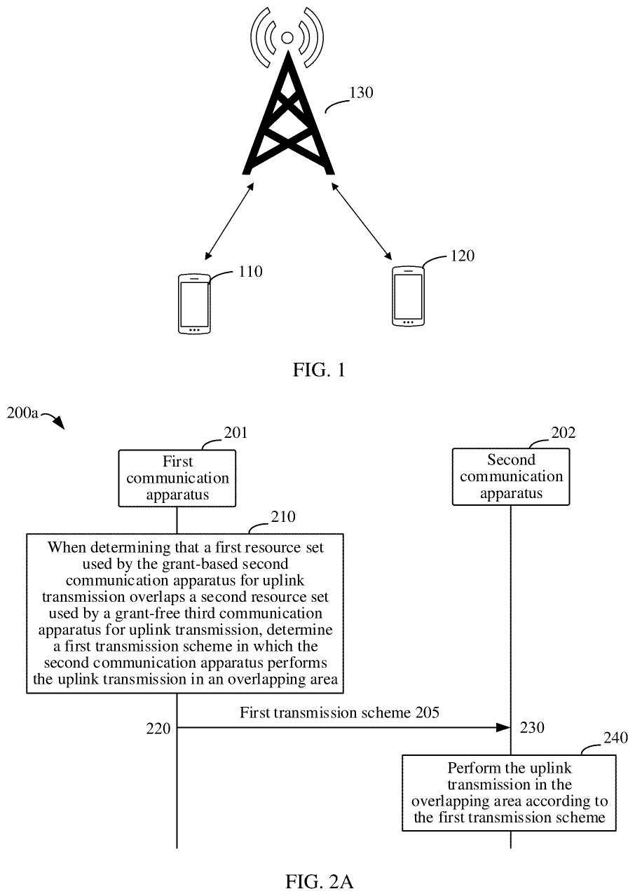

As shown in FIG. 1, a communication method provided in this embodiment may be applied to a 5G NR system, or may be applied to another communication system, for example, a next-generation (6G) communication system, and may be applied to any network having a preallocation mode. Network elements in embodiments of the embodiments are a network device 130 and terminal devices 110 and 120. In this scenario, the network device 130 is an entity configured to transmit or receive a signal on a network side. The network device 130 may be a base station, for example, a BS, a NodeB, an eNB, or a gNB. The terminal devices 110 and 120 are entities configured to receive or transmit signals on a user equipment side. The terminal devices 110 and 120 may be UEs (user equipments), for example, mobile phone terminals. One of the terminal devices 110 and 120 (for example, the terminal device 110, which may also be referred to as a first terminal device 110) may send a request to the network device 130, to request the base station to allocate a physical layer channel resource for transmission. The other one of the terminal devices 110 and 120 (for example, the terminal device 120, which may also be referred to as a second terminal device 120) may perform transmission based on a physical layer channel resource pre-configured by the network device 130. In other words, the second terminal device 120 may be GF user equipment, and the first terminal device 110 may be GB user equipment. In this case, a collision may occur between physical layer channel resources corresponding to the terminal devices 110 and 120. A relay device (not shown in FIG. 1) may be further mentioned. The relay device is an entity that can receive data from a terminal, a base station, or another relay, and forward the data to another terminal, the base station, or the another relay. A quantity of terminal devices and a quantity of network devices in embodiments are not limited by a quantity of devices listed above.

It should be understood that the network device 130 may be a network device in various network systems. For example, the network device 130 may be any device having a wireless transceiver function. The network device 130 includes, but is not limited to: a conventional macro base station evolved NodeB (eNB) in a conventional Universal Mobile Telecommunications system, universal mobile telecommunications system/Long Term Evolution, long term evolution (UMTS/LTE) wireless communication system, a micro base station eNB in a Heterogeneous Network (HetNet) scenario, a baseband processing unit BBU (baseband unit) and a radio frequency unit Remote Radio Unit, remote radio unit (RRU) in a distributed base station scenario, a baseband pool BBU pool and a radio frequency unit RRU in a Cloud Radio Access Network, cloud radio access network (CRAN) scenario, a gNB in a future wireless communication system, an evolved base station in 3GPP, an access node in a Wi-Fi system, a wireless relay node, a wireless backhaul node, and the like. The base station may be a macro base station, a micro base station, a picocell base station, a small cell, a relay station, a balloon station, or the like. The network device 130 may alternatively be a server, a wearable device, a vehicle-mounted device, or the like.

The terminal devices 110 and 120 each may alternatively be various user communication devices, for example, may be a vehicle-mounted communication module or another embedded communication module, a mobile phone, a tablet computer (Pad), a computer having a wireless transceiver function, a virtual reality (VR) terminal device, an augmented reality (AR) terminal device, a wireless terminal in industrial control, a tactile terminal device, a vehicle-mounted terminal device, a wireless terminal in self driving, a wireless terminal in telemedicine (remote medical), a wireless terminal in a smart grid, a wireless terminal in transportation safety, a wireless terminal in a smart city, a wireless terminal in a smart home, a wearable terminal device, or the like.

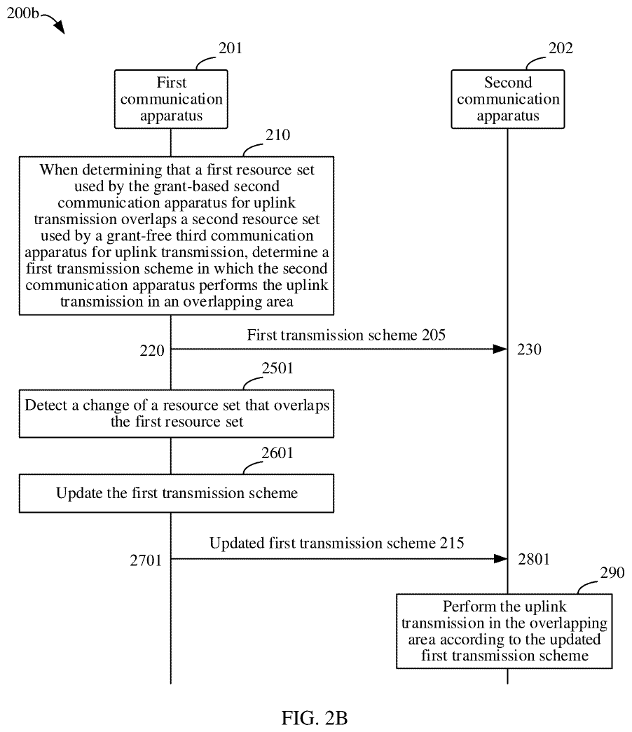

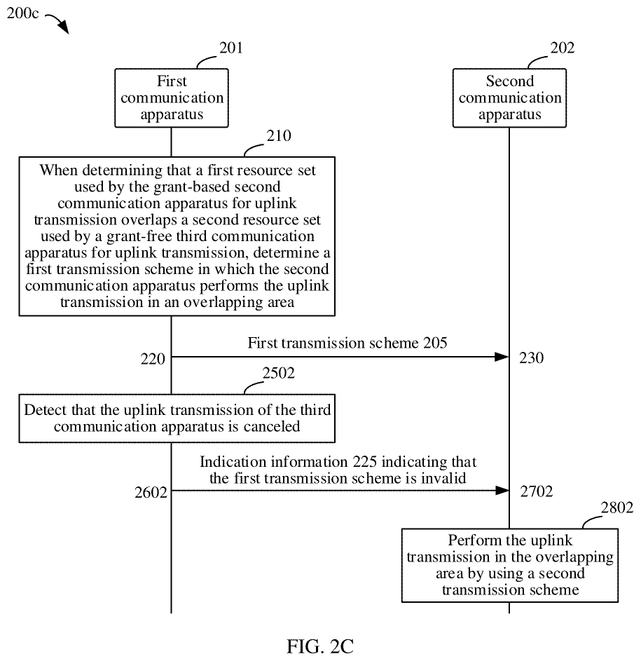

FIG. 2A is a diagram of an example procedure of a communication method according to an embodiment. As shown in FIG. 2A, in an example procedure 200a of a communication method according to some embodiments, when a first communication apparatus 201 determines that a first resource set used by a grant-based second communication apparatus 202 for uplink transmission overlaps a second resource set used by a grant-free third communication apparatus for uplink transmission, the first communication apparatus 201 determines (210) a first transmission scheme 205 in which the second communication apparatus 202 performs the uplink transmission in an overlapping area. The first transmission scheme 205 includes at least one of a first channel coding scheme and a first multiple access scheme, and the overlapping area is determined by performing area division on a time-frequency resource of the second communication apparatus 202 based on the overlapping. The first communication apparatus 201 outputs (220) the first transmission scheme 205. On the second communication apparatus 202 side, the grant-based second communication apparatus 202 receives (230) the first transmission scheme 205 from a network device 130, and the second communication apparatus 202 may receive indication information from the network device 130. The indication information indicates the first transmission scheme 205 in which the second communication apparatus 202 performs the uplink transmission in the overlapping area. The second communication apparatus 202 performs (240) the uplink transmission in the overlapping area according to the first transmission scheme 205.

In some embodiments, the first communication apparatus 201 may be the network device 130, a chip located in the network device 130, or the like. In some embodiments, the second communication apparatus 202 may be a first terminal device 110, a chip located in the first terminal device 110, or the like. In some embodiments, the third communication apparatus may be a second terminal device 120, a chip located in the second terminal device 120, or the like. For example, the network device 130 may be a base station, and the terminal device (the first terminal device 110 or the second terminal device 120) may be a UE (user equipment). It should be noted that the network device 130 is not limited to the base station, and the terminal device is not limited to the UE. In some embodiments, the grant-based second communication apparatus 202 (for example, the first terminal device 110) may be a GB user equipment. In some embodiments, the grant-free third communication apparatus (for example, the second terminal device 120) may be a GF user equipment.

In some embodiments, the grant-free third communication apparatus may be a grant-free communication apparatus group. In some embodiments, the grant-free third communication apparatus may be a grant-free GF user equipment group.

In some embodiments, the first communication apparatus 201 determines the first transmission scheme 205. For example, the first communication apparatus 201 may divide, based on the area division, a transport block of the first terminal device 110 into a sub-code block, and determine a channel coding scheme and related parameters corresponding to a sub-code block in the overlapping area. In this implementation, the first communication apparatus 201 (for example, the network device 130) adjusts, by independently adjusting the channel coding scheme and related parameters, a transmission scheme in which the second communication apparatus 202 (for example, the first terminal device 110) performs the uplink transmission in the overlapping area, to determine the first transmission scheme 205.

In some embodiments, the channel coding scheme and related parameters may include a channel coding method and a channel coding parameter corresponding to the channel coding method.

In some embodiments, a specific manner in which the first communication apparatus 201 determines the channel coding scheme and related parameters corresponding to the sub-code block in the overlapping area may be reducing a code block length of the sub-code block in the overlapping area. Correspondingly, on the second communication apparatus 202 side, a new code block length that is of the sub-code block in the overlapping area and that is less than a preset code block length is obtained. In some embodiments, a specific manner in which the first communication apparatus 201 determines the channel coding scheme and related parameters corresponding to the sub-code block in the overlapping area may be lowering a code rate of the sub-code block in the overlapping area. Correspondingly, on the second communication apparatus 202 side, a new code rate that is of the sub-code block in the overlapping area and that is less than a preset code rate is obtained. In some embodiments, a specific manner in which the first communication apparatus 201 determines the channel coding scheme and related parameters corresponding to the sub-code block in the overlapping area may be using a channel coding method that matches a size of data that can be carried in the overlapping area. In some embodiments, a manner in which the first communication apparatus 201 determines the channel coding scheme and related parameters corresponding to the sub-code block in the overlapping area may be one or a combination of the foregoing mentioned manners.

In some embodiments, the first communication apparatus 201 determines the first transmission scheme. For example, the first communication apparatus 201 may determine a multiple access scheme and related parameters corresponding to the overlapping area. In this implementation, the first communication apparatus 201 (for example, the network device 130) adjusts, by independently adjusting the multiple access scheme and related parameters, the transmission scheme in which the second communication apparatus 202 (for example, the first terminal device 110) performs the uplink transmission in the overlapping area, to determine the first transmission scheme 205.

In some embodiments, the first communication apparatus 201 determines the first transmission scheme. For example, the manner of independently adjusting the channel coding scheme and related parameters and the manner of independently adjusting the multiple access scheme and related parameters may be combined.

In some embodiments, the first communication apparatus 201 determines the multiple access scheme and related parameters. For example, based on the first terminal device 110 and the second terminal device 120 both using orthogonal multiple access in the overlapping area, the first communication apparatus 201 may adjust a parameter of the multiple access scheme by performing at least one of the following operations: lowering a modulation order or limiting a transmission signal. In some embodiments, the first communication apparatus 201 determines the multiple access scheme and related parameters. For example, based on the first terminal device 110 using orthogonal multiple access in the overlapping area and the second terminal device 120 using non-orthogonal multiple access in the overlapping area, the first communication apparatus 201 may switch a multiple access scheme of the first terminal device 110 to a non-orthogonal multiple access scheme. In some embodiments, the first communication apparatus 201 determines the multiple access scheme and related parameters. For example, based on the first terminal device 110 and the second terminal device 120 both using non-orthogonal multiple access in the overlapping area, the first communication apparatus 201 may determine that the first terminal device 110 keeps a non-orthogonal multiple access scheme. In the non-orthogonal multiple access scheme that is switched to or kept in the foregoing embodiments, the first communication apparatus 201 may indicate the first terminal device 110 to select a parameter of the multiple access scheme based on interference from the second terminal device 120.

In some embodiments, the first transmission scheme further includes an interleaving scheme. In some embodiments, the interleaving scheme may include interleaving data encoded by using the first channel coding scheme, where interleaved data corresponding to the same overlapping area includes encoded data corresponding to at least one sub-code block, and the sub-code block is obtained by dividing the transport block of the first terminal device 110. In some embodiments, the interleaving scheme may include interleaving data processed by using the first multiple access scheme, where interleaved data corresponding to the same overlapping area includes processed data corresponding to at least one sub-data sequence, and the sub-data sequence is obtained by dividing data processed by the first terminal device 110 by using the first multiple access scheme. In some embodiments, the interleaving may be implemented by combining the implementation of interleaving the data encoded by using the first channel coding scheme and interleaving the data processed by using the first multiple access scheme.

In some embodiments, the first transmission scheme further includes a symbol-to-resource mapping rule corresponding to the overlapping area. In some embodiments, determining the first transmission scheme may include: the first communication apparatus 201 modifies an overall symbol-to-resource mapping rule to a local mapping rule, where the local mapping rule includes the mapping rule corresponding to the overlapping area, and the mapping rule corresponding to the overlapping area and a mapping rule corresponding to an area other than the overlapping area are independent of each other.

In some embodiments, the overlapping area is determined by the first communication apparatus 201 based on a time-frequency position of the second resource set and a constraint related to a channel coding scheme. For example, in the foregoing embodiments in which the first transmission scheme 205 is determined by independently adjusting the channel coding scheme and related parameters, the overlapping area may be determined in this manner. The overlapping area is determined based on the time-frequency position of the second resource set and the constraint related to the channel coding scheme. For example, the overlapping area is determined based on at least one piece of overlap being covered in a frequency band of the overlapping area and no overlap exists in bandwidth of a non-overlapping area, and based on constraints such as a modulation scheme, a coding rate, and a minimum CB code length.

In some embodiments, the overlapping area is determined by the first communication apparatus 201 based on a time-frequency position of the second resource set and a constraint related to a multiple access scheme. For example, in the foregoing embodiments in which the first transmission scheme 205 is determined by independently adjusting the multiple access scheme and related parameters, the overlapping area may be determined in this manner. The overlapping area is determined based on the time-frequency position of the second resource set and the constraint related to the multiple access scheme. For example, the overlapping area is determined based on at least one piece of overlap being covered in a frequency band of the overlapping area and no overlap exists in bandwidth of a non-overlapping area. An area outside the overlapping area is a non-overlapping area. In some embodiments, for example, in embodiments in which the first transmission scheme 205 is determined by combining the manner of independently adjusting the channel coding scheme and related parameters and the manner of independently adjusting the multiple access scheme and related parameters, when the overlapping area is determined, the time-frequency position of the second resource set, the constraint related to the channel coding scheme, and the constraint related to the multiple access scheme each may be considered. In some embodiments, the overlapping area determined based on the time-frequency position of the second resource set and the constraint related to the channel coding scheme can be larger than the overlapping area determined based on the time-frequency position of the second resource set and the constraint related to the multiple access scheme. Therefore, when the two manners are combined, the overlapping area determined based on the time-frequency position of the second resource set and the constraint related to the channel coding scheme can beused.

In some embodiments, the first communication apparatus 201 determines that the first resource set also overlaps a third resource set of a grant-free third terminal device, and may further determine an overlapping area set in the first resource set based on the time-frequency position of the second resource set and a time-frequency position of the third resource set, where the overlapping area belongs to the overlapping area set.

In some embodiments, the first communication apparatus 201 may further determine, when it is assumed that the overlapping does not exist, a second transmission scheme in which the first terminal device 110 performs the uplink transmission, where the second transmission scheme includes at least one of a second channel coding scheme and a second multiple access scheme. The first communication apparatus 201 may further output the second transmission scheme. The second transmission scheme may be an initial transmission scheme determined by the first communication apparatus 201 under a collision-free assumption, and may be denoted as Trans1. The first transmission scheme may be an adjusted transmission scheme determined by the base station later based on a resource overlapping (or referred to as a collision) status between the second communication apparatus 202 (for example, the first terminal device 110) and the third communication apparatus (for example, the second terminal device 120), and may be denoted as Trans2. If there are a plurality of overlapping areas (or referred to as collision areas), the overlapping areas may be sequentially denoted as Trans2(i) (i represents a sequence number of the overlapping area).

In some embodiments, before the first terminal device 110 performs the uplink transmission, the first communication apparatus 201 detects a change of a resource set that overlaps the first resource set, and may update the first transmission scheme in which the first terminal device 110 performs the uplink transmission in the overlapping area, where a changed resource set includes one of the following: an updated second resource set; the second resource set and the third resource set of the grant-free third terminal device that also overlaps the first resource set; and the third resource set and the updated second resource set. The first communication apparatus 201 may output an updated first transmission scheme.

In some embodiments, the updated second resource set is that the second resource set is updated. An example in which the grant-free second terminal device 120 is the GF user equipment group is used. A resource set used by a first GF user equipment group for the uplink transmission overlaps the second resource set used by the GB user equipment for the uplink transmission. The second resource set is a resource set corresponding to the overlapping. When the uplink transmission of a part of GF user equipments (not all the GB user equipments) in the first GF user equipment group is canceled, the second resource set may be changed. For example, one or more originally overlapped resources of the GF user equipment no longer overlap a resource of the GB user, and correspondingly, the resource no longer belongs to the second resource set. In this case, the second resource set is updated. In other words, a resource decrease occurs in the resource set that overlaps the resource set used by the GB user equipment for the uplink transmission. The changed resource set includes the updated second resource set.

In some embodiments, for a resource set of the grant-free third terminal device that also overlaps the first resource set, refer to the foregoing example. For example, in addition to the first GF user equipment group, a second GF user equipment group also overlaps the resource set used by the GB user equipment for the uplink transmission. In this case, an overlapping resource set may be referred to as the third resource set. In other words, on a basis of the second resource set, the third resource set appears. In this case, a resource increase occurs in the resource set that overlaps the resource set used by the GB user equipment for the uplink transmission. The changed resource set includes the resource set of the grant-free third terminal device that also overlaps the first resource set.

In some embodiments, the resource increase and the resource decrease in the resource set that overlaps the resource set used by the GB user equipment for the uplink transmission may simultaneously occur, that is, the changed resource set may include the third resource set and the updated second resource set.

In some embodiments, the first communication apparatus 201 updates the first transmission scheme 205. For example, the first communication apparatus 201 may update the overlapping area set in the first resource set based on a time-frequency position of the changed resource set, where the overlapping area belongs to the overlapping area set. The first communication apparatus 201 determines the updated first transmission scheme based on an updated overlapping area set.

In some embodiments, on the second communication apparatus 202 side, before performing the uplink transmission, the second communication apparatus 202 may receive, from the network device 130, the updated first transmission scheme and indication information of a corresponding updated overlapping area, and perform the uplink transmission in the updated overlapping area according to the updated first transmission scheme.

FIG. 2B is a diagram of another example procedure of a communication method according to an embodiment. As shown in FIG. 2B, in a procedure 200b, when a first communication apparatus 201 determines that a first resource set used by a grant-based second communication apparatus 202 for uplink transmission overlaps a second resource set used by a grant-free third communication apparatus for uplink transmission, the first communication apparatus 201 determines (210) a first transmission scheme 205 in which the second communication apparatus 202 performs the uplink transmission in an overlapping area. The first transmission scheme 205 includes at least one of a first channel coding scheme and a first multiple access scheme, and the overlapping area is determined by performing area division on a time-frequency resource of the second communication apparatus 202 based on the overlapping. The first communication apparatus 201 outputs (220) the first transmission scheme 205. On the second communication apparatus 202 side, the grant-based second communication apparatus 202 receives (230) the first transmission scheme 205 from a network device 130. The second communication apparatus 202 may receive the first transmission scheme 205 by receiving indication information from the network device 130. The indication information may indicate the first transmission scheme 205. The first communication apparatus 201 detects (2501) a change of a resource set that overlaps the first resource set, and the first communication apparatus 201 updates (2601) the first transmission scheme 205. The first communication apparatus 201 outputs (2701) an updated first transmission scheme 215. On the second communication apparatus 202 side, after receiving (2801) the updated first transmission scheme 215 from the network device 130, the grant-based second communication apparatus 202 performs (290) the uplink transmission in the overlapping area according to the updated first transmission scheme 215.

In some embodiments, before a first terminal device 110 performs the uplink transmission, the first communication apparatus 201 detects that the uplink transmission of a second terminal device 120 is canceled, and may send, to the first terminal device 110, indication information indicating that the first transmission scheme is invalid.

In some embodiments, on the second communication apparatus 202 side (for example, the first terminal device 110 side), before performing the uplink transmission, the second communication apparatus 202 receives, from the network device 130, the indication information indicating that the first transmission scheme is invalid. The second communication apparatus 202 performs the uplink transmission in the overlapping area by using a second transmission scheme, where the second transmission scheme is a transmission scheme that is determined by the network device 130 when it is assumed that the overlapping does not exist and in which the second communication apparatus 202 performs the uplink transmission.

In some embodiments, the second terminal device 120 may be a grant-free terminal device group. For the grant-free terminal device group, that the uplink transmission of the second terminal device 120 is canceled means that uplink transmission of all grant-free terminal devices in the group is canceled.

FIG. 2C is a diagram of still another example procedure of a communication method according to an embodiment. As shown in FIG. 2C, in a procedure 200c, when a first communication apparatus 201 determines that a first resource set used by a grant-based second communication apparatus 202 for uplink transmission overlaps a second resource set used by a grant-free third communication apparatus for uplink transmission, the first communication apparatus 201 determines (210) a first transmission scheme 205 in which the second communication apparatus 202 performs the uplink transmission in an overlapping area. The first transmission scheme 205 includes at least one of a first channel coding scheme and a first multiple access scheme, and the overlapping area is determined by performing area division on a time-frequency resource of the second communication apparatus 202 based on the overlapping. The first communication apparatus 201 outputs (220) the first transmission scheme 205. On the second communication apparatus 202 side, the grant-based second communication apparatus 202 receives (230) the first transmission scheme 205 from a network device 130. In some embodiments, the second communication apparatus 202 may receive the first transmission scheme 205 by receiving indication information indicating the first transmission scheme 205 from the network device 130. The first communication apparatus 201 detects (2502) that the uplink transmission of the third communication apparatus (for example, a second terminal device 120) is canceled, and the first communication apparatus 201 sends (2602), to a first terminal device 110, indication information 225 indicating that the first transmission scheme 205 is invalid. The indication information 225 indicating that the first transmission scheme 205 is invalid is different from the indication information indicating the first transmission scheme 205. On the second communication apparatus 202 side, the grant-based second communication apparatus 202 receives (2702) the indication information 225 from the network device 130, and the second communication apparatus 202 performs (2802) the uplink transmission in the overlapping area by using a second transmission scheme.

In some embodiments, the first communication apparatus 201 outputs the first transmission scheme 205 or the second transmission scheme by using signaling. The signaling used to output the first transmission scheme 205 or the second transmission scheme may include one or more of the following information: a length of a transport block of the first terminal device 110, a transmission scheme type, a transmission scheme quantity, and transmission scheme content. For example, the signaling may further include a time-frequency resource position of the first terminal device 110. The transmission scheme type may indicate different first transmission schemes, different second transmission schemes, and the like, where first transmission schemes indicated by different types have different content.

In some embodiments, the length of the transport block of the first terminal device 110 is, for example, a TB length of a GB user equipment. The time-frequency resource position of the first terminal device 110, for example, an RB resource position of the GB user equipment, may be indicated by using {time domain start position, time domain end position, frequency domain start position, frequency domain end position} or pattern information of a valid time-frequency resource position. The transmission scheme type may indicate different first transmission schemes, different second transmission schemes, and the like. For example, for example, 0 indicates the second transmission scheme. For example, normal transmission is performed without area division. Other numbers indicate different first transmission schemes. For example, 1 indicates that the first transmission scheme is a CB area coding based transmission scheme (refer to descriptions of a “second embodiment”), 2 indicates that the first transmission scheme is a NOMA area coding based transmission scheme (refer to descriptions of a “first embodiment”), 3 indicates that the first transmission scheme is a transmission scheme jointly adjusted according to a NOMA coding scheme and a CB (code block) coding scheme (refer to descriptions of a “third embodiment”), 4 indicates that the first transmission scheme is a CB random interleaving based transmission scheme (refer to descriptions of a “fourth embodiment”), and 5 indicates that the first transmission scheme is a NOMA random interleaving based transmission scheme (refer to descriptions of a “fifth embodiment”). The first transmission scheme corresponds to a specific area, for example, an area 0. Content of the transmission scheme may include, but is not limited to, a time-frequency resource position corresponding to the area 0, a CB coding scheme and related parameters in the area 0, a NOMA scheme and related parameters in the area 0, a precoding scheme and related parameters in the area 0, a mapping scheme in the area 0 (such as a symbol-to-resource mapping rule), and the like. The time-frequency resource position corresponding to the area 0 represents an applicable area of the transmission scheme applied in the area 0, and may be determined by using bandwidth of an applicable frequency domain, a start position and an end position in the frequency domain, a quantity of symbols in an applicable time domain, a start symbol position and an end symbol position in the time domain, and the like.

In some embodiments, the first communication apparatus 201 also outputs the second transmission scheme by using the signaling for outputting the first transmission scheme 205. In some other embodiments, the first communication apparatus 201 outputs the second transmission scheme by using signaling (such as other signaling) different from the signaling for outputting the first transmission scheme 205. In some embodiments, when the first communication apparatus 201 sends the first transmission scheme 205 and the second transmission scheme to the second communication apparatus 202, the second communication apparatus 202 may correspondingly receive the second transmission scheme by receiving the signaling of the first transmission scheme 205 or the other signaling.

In some embodiments, the indication information indicating the first transmission scheme in which the second communication apparatus 202 performs the uplink transmission in the overlapping area may include position information of a time-frequency resource corresponding to the overlapping area. The indication information may indicate the bandwidth of the applicable frequency domain, the start position and the end position in the frequency domain, the quantity of symbols in the applicable time domain, and the start symbol position and the end symbol position in the time domain. Correspondingly, the first terminal device 110 may determine a specific position of the overlapping area by using the position information of the time-frequency resource corresponding to the overlapping area.

For example, the first communication apparatus 201 is a base station, the second communication apparatus 202 is a GB user equipment, and the third communication apparatus is a GF user equipment. Due to interference from the GF user equipment, a received SNR of the GB user equipment in a collision area is clearly lower than a received SNR of the GB user equipment in a non-collision area. In this case, if a signal-to-noise ratio under a collision-free assumption is used to select a transmission parameter, a clear performance loss of the GB user is inevitably caused. In this embodiment, an architecture of a transmit end is modified to enable a user area-level transmission scheme and adapt to a scenario in which SNRs are unbalanced in a GF and GB collision scenario. The user equipment may be, for example, a UE.

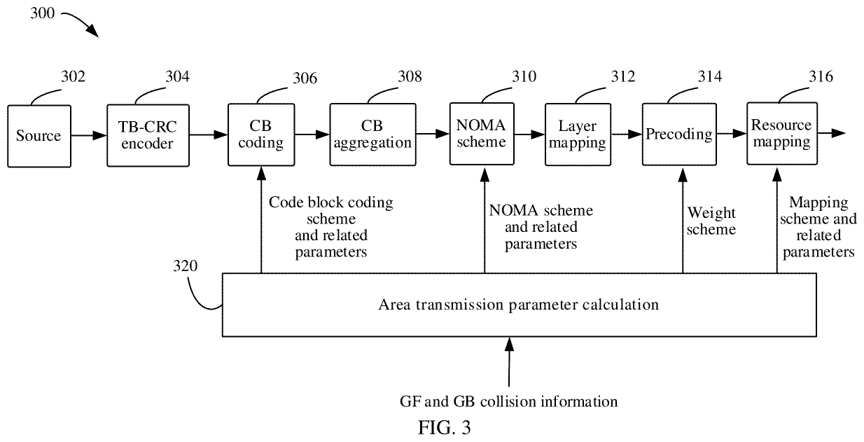

FIG. 3 is a diagram of a communication procedure on which an embodiment is based. As shown in FIG. 3, in the communication procedure 300, after data from a source 302 is encoded by a TB-CRC encoder 304, the data is subjected to steps such as CB coding 306 and CB aggregation 308, and then processed through a NOMA scheme 310, layer mapping 312, precoding 314, resource mapping 316, and the like. Area transmission parameter calculation 320 is related in the following steps: the CB coding 306, the NOMA scheme 310, the precoding 314, and the resource mapping 316. Refer to FIG. 3. The steps respectively relate to calculation of related parameters such as a parameter in a code block coding scheme, a parameter in the NOMA scheme, a parameter in a weight scheme, and a parameter in a mapping scheme, and correspondingly may further relate to determining of the code block coding scheme, the NOMA scheme, the weight scheme, and the mapping scheme. Information about a time-frequency resource collision between a GF user equipment and a GB user equipment may be considered for determining the foregoing parameters. The code block coding scheme is a process of splitting a data stream obtained through TB-CRC coding into a plurality of CB code blocks, and independently performing channel coding on a bit of each CB code block. It is assumed that a TB block is segmented into N_{CB} CBs in total. A coding scheme and related parameters corresponding to a CB i include at least a coding scheme Method-i, a code length Bᵢ, and an equivalent code rate Rᵢ obtained through rate matching, and further need to include a coding parameter needed for CB channel coding. The coding scheme may be LDPC coding, Polar coding, Turbo coding, or another coding scheme. Each specific coding scheme also includes a unique channel coding parameter of the coding scheme. LDPC channel coding is used as an example. In this case, the coding parameters further need to include a coding factor graph Graphᵢ, and different code lengths correspond to different Graphᵢ, to obtain a larger coding gain. The NOMA (non-orthogonal multiple access) scheme is a process of mapping an encoded bit stream into a symbol sequence. This process supports multiple access schemes such as OMA (orthogonal multiple access) and NOMA. The OMA is an orthogonal multiple access technology, including OFDMA and the like. The OFDMA is used as an example. A group of K bits are mapped into one symbol through QAM modulation. The NOMA is non-orthogonal multiple access, including SCMA and the like. The SCMA is used as an example. A group of K bits are mapped into N symbols by using an SCMA codebook. The parameters in the NOMA scheme include at least (K, N, CIdx), and CIdx indicates a mapping codebook used in the NOMA scheme of the user. The OFDMA is used as an example. CIdx is a QAM modulation scheme. For MUSA access, CIdx is a used spreading sequence. For SCMA access, CIdx is a codebook sequence number of the SCMA access. Resource mapping is a process of mapping a precoded symbol data stream into a time-frequency resource.

To minimize interference impact of the GF user equipment, in some embodiments, the interference impact of the GF user equipment is limited to a specific area based on area division. A code block coding scheme and related parameters, a NOMA scheme and related parameters, and the like in the area are modified to implement transmission matching an SNR of the area, and a transmission scheme (code block coding, NOMA, and the like) in an area that is not affected by interference from the GF user equipment does not change. Optionally or additionally, some other embodiments utilize a concept of interference equalization to spread the interference to all data by using an interleaving mechanism. In some embodiments, the interleaving mechanism may be used in a symbol domain (after the NOMA scheme). In some other embodiments, the interleaving mechanism may be used after coding (after the CB (code block) coding). Modifying the coding scheme and related parameters in the area (corresponding to an area-level channel coding scheme), modifying the NOMA scheme and related parameters in the area (corresponding to an area-level NOMA scheme), and the like are transmission scheme adjustment based on an idea of interference impact limitation when the GB user equipment is scheduled. For the area-level channel coding scheme, CB variable-length segmentation enables a single CB to cover a collision area, and the independent coding scheme and related parameter for the CB is used to ensure that the interference impact on the CB is minimized. For the area-level NOMA scheme, an independent NOMA scheme and related parameters are selected for the collision area obtained through division, to minimize the interference impact. Introduction of random interleaving can correspond to an idea of interference randomization. A symbol interleaving mechanism is introduced after the NOMA scheme, so that NOMA schemes in a plurality of areas jointly bear the interference impact. A bit interleaving mechanism is introduced after the channel coding scheme, so that a plurality of CB code blocks jointly bear the interference impact. In this embodiment, the channel coding scheme and the NOMA scheme may be independent of each other, that is, may be separately implemented, or may be jointly implemented to achieve a better effect.

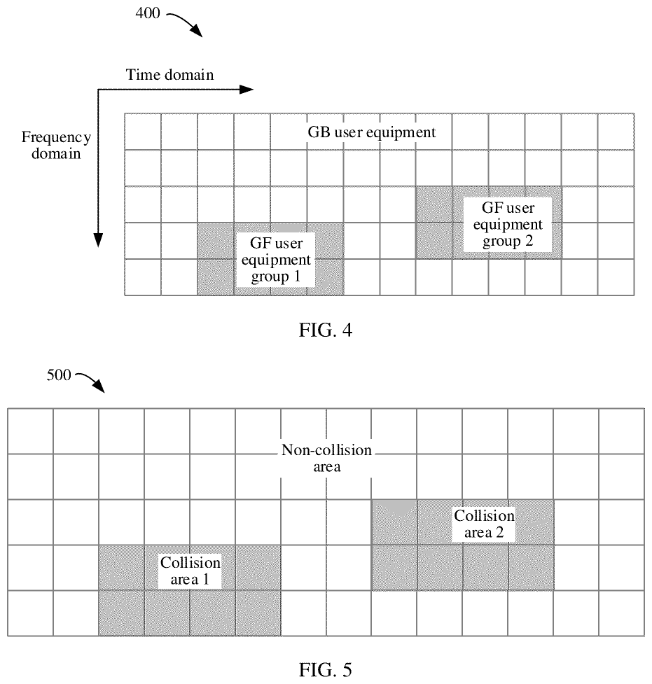

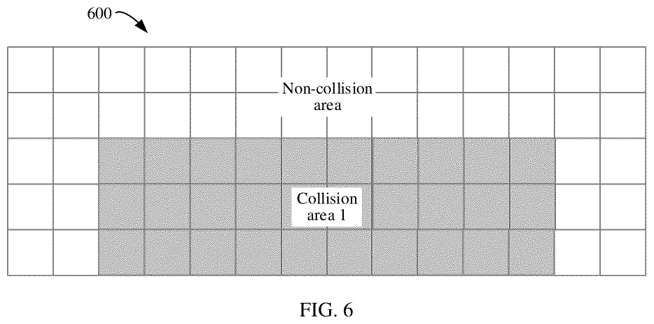

In some embodiments, the area division is: when a resource collision between GF and GB occurs, a base station needs to divide a time-frequency resource of the GB user equipment into several collision areas and non-collision areas based on a GF/GB resource collision status in time domain and frequency domain. There are a plurality of area division manners, and the area division is restricted and limited by a plurality of transmission parameters. In some embodiments, a time-frequency resource in a collision area covers at least one GB/GF resource collision, and bandwidth of a non-collision area does not have a GF/GB resource collision. FIG. 4, FIG. 5, and FIG. 6 respectively show collision area division in some embodiments. A collision division example 400 in FIG. 4 shows a case in which collisions with two GF user equipment groups are encountered on time-frequency resources of a GB user equipment, and the collisions with the two GF user equipment groups (a GF user equipment group 1 and a GF user equipment group 2) are respectively located on different time-frequency resources. A collision division example 500 in FIG. 5 shows a case in which two collision areas (a collision area 1 and a collision area 2) and one non-collision area may be obtained through division when a transmission parameter constraint is met. A collision division example 600 in FIG. 6 shows a case in which one collision area (a collision area 1) and one non-collision area are obtained through division. It should be noted that, due to limitations of transmission parameters such as a modulation scheme, a coding rate, and a minimum CB code length, a time-frequency resource range of a collision area is not completely equal to that of an area in which a collision occurs, and can be slightly larger than that of the area in which the collision occurs. In addition, considering impact of a time-frequency resource in a non-collision area, the collision area obtained through division is not particularly large. When the GB/GF user equipment resource collision exists only on a part of time-frequency resources of the GB user equipment, at least one collision area and one non-collision area, that is, two areas in total are divided for one GB user equipment.

In some embodiments, first, the base station determines, under a collision-free assumption, a CB coding scheme and related parameters (N_{CB}, B_{c}, C_{r,c}, method_{c}), a NOMA scheme and related parameters (Kᵢ, Nᵢ, CIdxᵢ), a layer mapping scheme and related parameters (N_{Layer}), a precoding scheme and related parameters V, and the like of a UE, and defines the schemes as an initial transmission scheme denoted as Trans1. Then, the base station determines an adjusted transmission scheme based on a GF/GB resource collision status, where the adjusted transmission scheme is denoted as Trans2. If there are a plurality of collision areas, the collision areas are sequentially denoted as Trans2(i).

The following further describes, by using three embodiments, the transmission scheme adjustment based on the idea of interference impact limitation in embodiments. The three embodiments (a first embodiment, a second embodiment, and a third embodiment) respectively correspond to three forms of transmission scheme adjustment by the base station when the GB user equipment is scheduled: independent adjustment of the NOMA scheme and related parameters, independent adjustment of the CB coding scheme and related parameters, and joint adjustment of the NOMA scheme and related parameters and the CB coding scheme and related parameters.

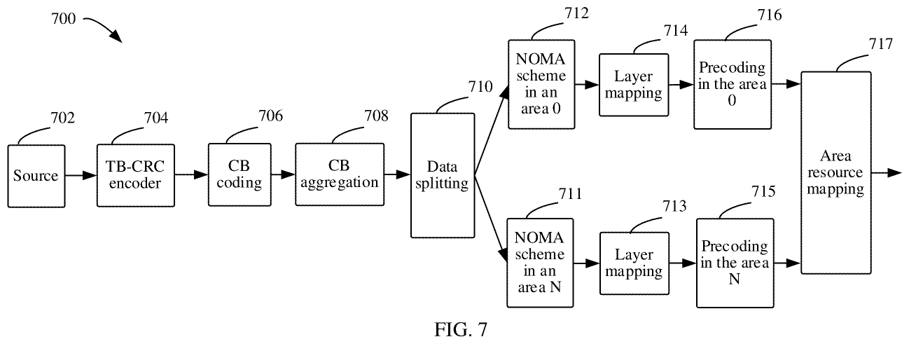

The first embodiment corresponds to the independent adjustment of the NOMA scheme and related parameters in the foregoing three forms of transmission scheme adjustment. In the first embodiment, for a block diagram of data sending of a GB user equipment, refer to FIG. 7. In the block diagram 700 of data sending, after data from a source 702 is encoded by a TB-CRC encoder 704, the data is subject to steps such as CB coding 706 and CB aggregation 708, and data splitting 710 is performed before a NOMA scheme. In the data splitting 710 step, area division is performed. The area division is performed to divide a time-frequency resource of a first terminal device into areas based on overlapping, where the areas may include an overlapping area and a non-overlapping area, for example, an area 0 and an area N. Then, for the area 0, a NOMA scheme 712 corresponding to the area 0, layer mapping 714, and precoding 716 in the area 0 are performed separately, and then area resource mapping 717 is performed. For the area N, a NOMA scheme 711 corresponding to the area N, layer mapping 713, and precoding 715 in the area N are performed, and then the area resource mapping 717 is performed. The area resource mapping 717 uses a local mapping rule to perform symbol-to-resource mapping. In other words, mapping rules in different areas are independent of each other, and a mapping rule in an area may be independently designed. A gNB modifies, based on known GF information, a NOMA scheme and an area mapping rule that are of the GB user equipment and that correspond to a collision area. The GF information may be an example of grant-free configuration information of a second terminal device. In some embodiments, a code rate in a CB coding scheme may be further adjusted based on a modification result, and then an adjusted code rate is delivered to the GB user equipment. A base station may calculate an average signal to interference plus noise ratio of each area, and determine a proper NOMA scheme and related parameters (Kᵢ, Nᵢ, CIdxᵢ) again for the area based on the signal to interference plus noise ratio. CIdxᵢ is a sequence number of a codebook (sequence) used in the NOMA scheme, Kᵢ is an information bit length input by the codebook of the NOMA scheme, and Nᵢ is a symbol length output by the codebook of the NOMA scheme. The NOMA scheme is a multiple access scheme. It should be noted that, OMA may be considered as a special NOMA scheme, a codebook CIdxᵢ of the OMA remains unchanged, and Nᵢ=1.

In some embodiments, an adjusted NOMA scheme and related parameters in a collision area 1≤i≤N are determined. For example, when the GB user equipment uses the OMA and the GF user equipment uses the OMA, the GB user equipment may keep OMA access, and actively lower an order through QAM modulation, or perform transmission of only an I-channel signal or a Q-channel signal, to determine the adjusted NOMA scheme. In some other embodiments, when the GB user equipment uses the OMA and the GF user equipment uses the NOMA, the GB user equipment may switch to NOMA access, and select a codebook (a sequence, where the codebook or the sequence is a parameter of the multiple access scheme) less interfered with by the GF user equipment to perform transmission, to determine an adjusted NOMA scheme. In still some other embodiments, when the GB user equipment uses the NOMA and the GF user equipment uses the NOMA, the GB user equipment may keep NOMA access (convert to an access scheme the same as that of the GF user equipment), and select a codebook (a sequence, where the codebook or the sequence is a parameter of the multiple access scheme) less interfered with by the GF user equipment to perform transmission, to determine an adjusted NOMA scheme.

For a non-collision area (i=0), the NOMA scheme and related parameters in the Trans1 scheme (the initial transmission scheme) may be used. However, if an SNR of the area allows support of more bits, K₀ of the area may also be increased, to ensure that a transmission rate is not reduced.

A quantity of bits sent by the GB user equipment is:

$$𝒦 = {\sum }_{i = 0}^{N} {K}_{i} \times ( \frac{{N}_{Re , i} \times {N}_{symb , i} \times {N}_{Layer}}{{N}_{i}} )$$

Kᵢ is a quantity of bits carried in a NOMA symbol sequence (and is a modulation order and a quantity of modulation bits when the OMA is used). N_{Re,i} is a total quantity of REs in an i^{th} area. N_{symb,i} is a quantity of time-domain symbols. N_{Layer} is a quantity of layers. Nᵢ is a quantity of REs corresponding to the NOMA symbol sequence.

In this case, a CB coding code rate Cᵣ is adjusted as follows based on [symbol] :

$${C}_{r} = B / 𝒦$$

B is a length of a TB.

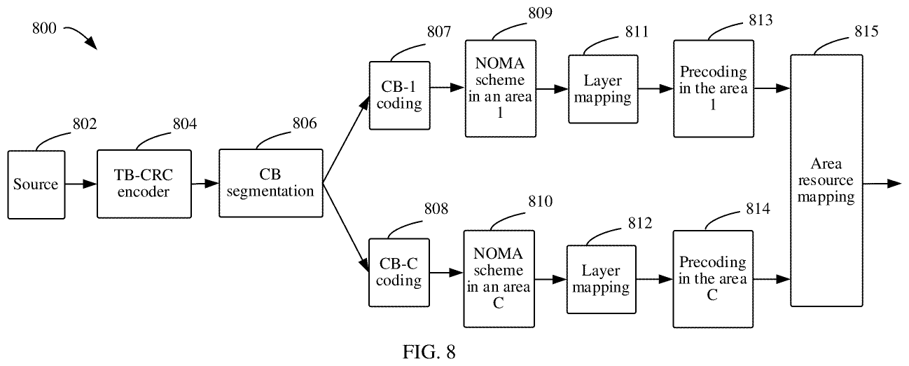

The second embodiment corresponds to the independent adjustment of the CB coding scheme and related parameters in the foregoing three forms of transmission scheme adjustment. In the second embodiment, for a block diagram of data sending of a GB user equipment, refer to FIG. 8. In the block diagram 800 of data sending, after data from a source 802 is encoded by a TB-CRC encoder 804, CB segmentation 806 is performed before CB coding is performed. In the CB segmentation 806 step, area division is performed. A transport block is divided into C sub-code blocks based on areas obtained through division. FIG. 8 shows an example of a subsequent processing procedure of a sub-code block 1 and a sub-code block C. The area division is performed to divide a time-frequency resource of a first terminal device into areas based on overlapping, and the areas obtained through division may include an overlapping area and a non-overlapping area. Corresponding to the sub-code block 1, CB-1 coding 807, a NOMA scheme 809 corresponding to an area 1, layer mapping 811, precoding 813 corresponding to the area 1, and other processing are performed separately, and then, area resource mapping 815 is performed. Corresponding to the sub-code block C, CB-C coding 808, a NOMA scheme 810 corresponding to an area C, layer mapping 812, precoding 814 corresponding to the area C, and other processing are performed separately, and then, the area resource mapping 815 is performed. The area resource mapping 815 uses a local mapping rule to perform symbol-to-resource mapping. In other words, mapping rules in different areas are independent of each other, and a mapping rule in an area may be independently designed. When a collision occurs, according to the second embodiment, the interference from a GF user equipment to the GB user equipment may be reduced by adjusting a CB coding scheme. In the second embodiment, the TB (transport block) may be divided into C sub-CBs (code blocks) based on an area, and each sub-CB covers a collision area or a non-collision area. Because sizes of CB areas are different, code lengths of different code blocks corresponding to different sub-CBs are also different in this case. In some embodiments, CB segmentation may support variable-length segmentation. CB coding parameters may be independently selected for different sub-code blocks. For example, the channel coding is LDPC coding. In this case, CB coding parameters of a sub-code block i include but are not limited to a code length Bᵢ, a code rate C_{r,i}, and Base Graph of the LDPC coding.

In the second embodiment, CB_{r,i} output after an i^{th} sub-code block is encoded is no longer aggregated with an output obtained by encoding another sub-code block, but mapping from a bit sequence to a symbol sequence, layer mapping, and precoding operations are completed according to a given NOMA scheme. It should be noted that, in this case, a NOMA scheme, a layer mapping scheme, and a precoding scheme that correspond to each sub-CB may not be modified, but the NOMA scheme, the layer mapping scheme, and the precoding scheme in Trans1 (the initial transmission scheme) are still used.

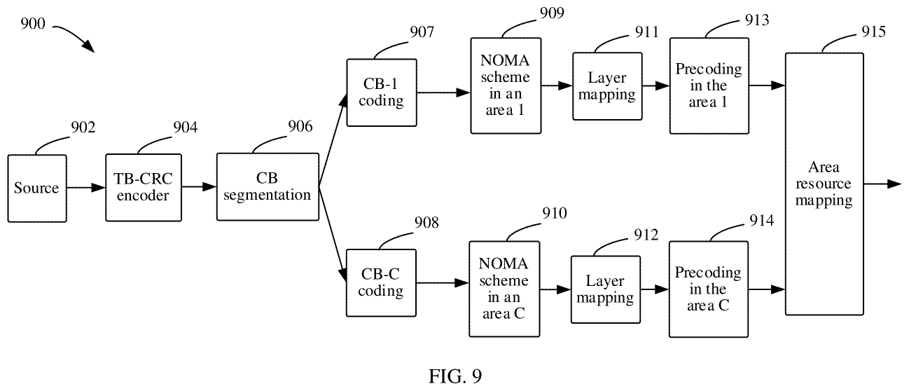

The third embodiment corresponds to the joint adjustment of the NOMA scheme and the CB coding scheme and related parameters in the foregoing three forms of transmission scheme adjustment. Refer to FIG. 9. In a block diagram 900 of data sending, after data from a source 902 is encoded by a TB-CRC encoder 904, CB segmentation 906 is performed before CB coding is performed. In the CB segmentation 906 step, area division is performed. A transport block is divided into C sub-code blocks based on areas obtained through division. The area division is performed to divide a time-frequency resource of a first terminal device into areas based on overlapping, and the areas obtained through division may include an overlapping area and a non-overlapping area. FIG. 9 shows an example of a subsequent processing procedure of a sub-code block 1 and a sub-code block C. Corresponding to the sub-code block 1, CB-1 coding 907, a NOMA scheme 909 corresponding to an area 1, layer mapping 911, precoding 913 corresponding to the area 1, and other processing are performed separately, and then, area resource mapping 915 is performed. Corresponding to the sub-code block C, CB-C coding 908, a NOMA scheme 910 corresponding to an area C, layer mapping 912, precoding 914 corresponding to the area C, and other processing are performed separately, and then, the area resource mapping 915 is performed. The area resource mapping 915 uses a local mapping rule to perform symbol-to-resource mapping. In other words, mapping rules in different areas are independent of each other, and a mapping rule in an area may be independently designed. According to the third embodiment, collision impact is reduced by adjusting both a CB coding scheme and a NOMA scheme. In this case, the following formula is met:

$$B = {\sum }_{i = 0}^{N} {K}_{i} \times ( \frac{{N}_{Re , i} \times {N}_{symb , i} \times {N}_{Layer}}{{N}_{i}} ) \times {C}_{r , i}$$

In the third embodiment, for a block diagram of data sending of a GB user equipment, refer to FIG. 9.

Still refer to the block diagram of data sending in FIG. 7, FIG. 8, or FIG. 9, after the transmission scheme is adjusted according to the first embodiment, the second embodiment, or the third embodiment, the base station further needs to adjust a symbol-to-resource mapping rule, to modify an original overall mapping rule to the local mapping rule.

In some embodiments, mapping rules in different areas may be independent of each other, and a mapping rule in an area may be independently designed. An area i is used as an example. In the area i, there is a total of N_{Re,i} resources in frequency domain, and N_{symb,i} time domain symbols are occupied, so that there is a total of N_{Re,i}×N_{symb,i} resources. It is assumed that S_{gb,i}=[s_{gb,i}(0), . . . , s_{gb,i}(N_{Re,i}×N_{symb,i}−1)]. A mapping sequence of Trans2(i) (an adjusted transmission scheme) in the area i may be that mapping is first performed in frequency domain and then in time domain, and a form after the mapping is:

$$[ \begin{matrix}{s}_{gb , i} ( 0 ) & {s}_{gb , i} ( {N}_{Re , i} ) & … & {s}_{gb , i} ( ( {N}_{symb , i} - 1 ) {N}_{Re , i} ) \\ ⋮ & ⋮ & ⋱ & ⋮ \\ {s}_{gb , i} ( {N}_{Re , i} - 1 ) & {s}_{gb , i} ( 2 \times {N}_{Re , i} - 1 ) & … & {s}_{gb , i} ( {N}_{symb , i} {N}_{Re , i} - 1 )\end{matrix} ]$$

A row direction of the matrix represents the time domain, and a column direction of the matrix represents the frequency domain.

Alternatively, a mapping sequence of Trans2(i) in the area i may be that mapping is first performed in time domain and then in frequency domain, and a form after the mapping is:

$$[ \begin{matrix}{s}_{gb , i} ( 0 ) & {s}_{gb , i} ( 1 ) & … & {s}_{gb , i} ( {N}_{symb , i} - 1 ) \\ ⋮ & ⋮ & ⋱ & ⋮ \\ {s}_{gb , i} ( ( {N}_{Re , i} - 1 ) {N}_{symb , i} ) & {s}_{gb , i} ( ( {N}_{Re , i} - 1 ) {N}_{symb , i} + 1 ) & … & {s}_{gb , i} ( {N}_{symb , i} {N}_{Re , i} - 1 )\end{matrix} ]$$

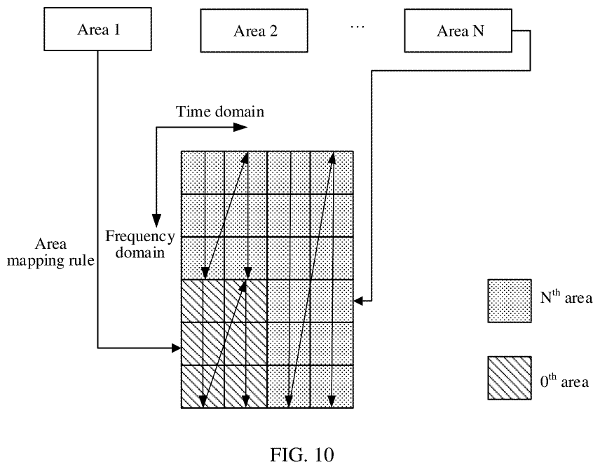

If a mapping area of the area i is irregular, irregular mapping may be further performed in a manner shown in FIG. 10. For example, N areas are determined through area division. In FIG. 10, two areas (such as N=2), for example, an area 0 and an area N are used as an example. For example, a mapping rule is used in the 0^{th} area, and a 2^{nd} mapping rule is used in the N^{th} area.

After determining an adjusted transmission scheme, a base station delivers the initial transmission scheme Trans1 and the adjusted transmission scheme Trans2(i),1≤i≤N of each collision area to a GB user equipment by using signaling. The initial transmission scheme Trans1 is a default scheme. The base station does not need to specify an area in which the initial transmission scheme Trans1 is applied, but needs to specify that the initial transmission scheme Trans1 is an initial transmission scheme. The adjusted transmission scheme Trans2(i) is an area-specific scheme. An area (bandwidth of an applicable frequency domain, start and end positions in the frequency domain, a quantity of symbols in an applicable time domain, and start and end symbol positions in the time domain) in which the adjusted transmission scheme Trans2(i) is applied, a transmission mode, and a transmission parameter need to be specified. According to the area-specific scheme in embodiments, the transmission scheme may be modified in a plurality of possible manners, to minimize interference impact of a GF user equipment.

A complete transmission scheme is carried in signaling and delivered to a UE side (for example, the GB user equipment). The signaling needs to include a total quantity N of areas obtained through division and a specific transmission scheme corresponding to each area obtained through division. Information about the signaling may be shown in Table 1.

TABLE 1

| | |
|---|---|
| TB length | XXX (a specific length value) |
| RB resource | {time domain start position, time |
| position | domain end position, frequency |
| | domain start position, |
| | frequency domain end position} |
| | or pattern information of a valid |
| | time-frequency resource position |
| Transmission | 0: Normal transmission |
| scheme | without area division |
| | 1: CB area coding |
| | 2: NOMA area coding |
| | 3: Joint adjustment of the NOMA |
| | coding scheme and the CB coding scheme |
| | 4: CB random interleaving |
| | 5: NOMA random interleaving |
| | . . . |
| Quantity of | N |
| area schemes | |
| Transmission | Time-frequency resource |
| scheme in | position of the area 0 |
| the area 0 | CB coding scheme and related |
| | parameters in the area 0 |
| | NOMA scheme and related |
| | parameters in the area 0 |
| | Precoding scheme and related |
| | parameters in the area 0 |
| | Mapping scheme in the area 0 |
| Transmission | Omitted (refer to descriptions |
| scheme in | of the transmission scheme in the |
| an area k (1 < k < N) | area 0 or the area N) |
| Transmission | Time-frequency resource |
| scheme in | position of the area N |
| the area N | CB coding scheme and related |
| | parameters in the area N |
| | NOMA scheme and related |
| | parameters in the area N |
| | Precoding scheme and related |
| | parameters in the area N |
| | Mapping scheme in the area N |

In some embodiments, the initial transmission scheme Trans1 and the adjusted transmission scheme Trans2(i) may be carried in same signaling and delivered to the GB user equipment. In some other embodiments, the initial transmission scheme Trans1 and the adjusted transmission scheme Trans2(i) may be delivered to the GB user equipment at different moments by using different signaling. In some embodiments, the signaling may be delivered to the GB user equipment by using downlink control information (DCI).

Transmission scheme adjustment based on an idea of interference impact limitation can improve transmission performance of the GB user equipment when a GF/GB user equipment time-frequency resource collision occurs. For example, the GB user equipment uses OMA, and the GF user equipment uses the OMA. Compared with a performance gain of 1 dB in a conventional technology, a performance gain obtained by the GB user equipment by actively reducing a modulation order in a collision area may be 2 dB.

The following further describes, by using two embodiments, transmission scheme adjustment based on an idea of interference randomization in embodiments. The two embodiments (a fourth embodiment and a fifth embodiment) respectively correspond to transmission scheme adjustment by the base station in a form of adjusting a CB coding scheme and related parameters, adjusting a NOMA scheme and related parameters, and the like when the GB user equipment is scheduled. According to the fourth embodiment and the fifth embodiment, a random interleaving manner is introduced to reduce interference from the GF user equipment to the GB user equipment. It should be noted that the fourth embodiment and the fifth embodiment respectively use independent adjustment of the CB coding scheme and related parameters and independent adjustment of the NOMA scheme and related parameters as examples for description. In some other embodiments, multi-point joint adjustment may alternatively be performed.

Refer to descriptions of the foregoing embodiments. The base station first determines the initial transmission scheme Trans1 under a collision-free assumption, and then adjusts a scheme of each module based on information about the collision area. The following first describes an embodiment of adjusting a CB transmission scheme.

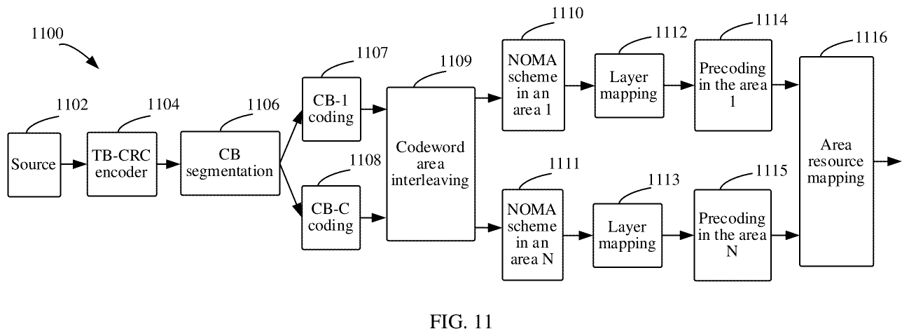

The fourth embodiment corresponds to the transmission scheme based on the independent adjustment of the CB coding scheme and related parameters when the random interleaving manner is introduced. For a block diagram of data sending of a GB user equipment, refer to a diagram of interleaving-based transmission scheme adjustment shown in FIG. 11 according to some embodiments. As shown in FIG. 11, in the block diagram 1100 of data sending, after data from a source 1102 is encoded by a TB-CRC encoder 1104, similar to the foregoing transmission scheme adjustment based on the idea of interference impact limitation, a GF/GB user equipment time-frequency resource collision also triggers CB segmentation 1106. One TB (transport block) is segmented into C CB sub-blocks (such as sub-code blocks). In this case, lengths of the CB sub-blocks may be different. Each CB sub-block also has an independent coding scheme and related parameters of the CB sub-block. For example, CB-1 coding 1107 and CB-C coding 1108 are respectively performed on a sub-code block 1 and a sub-code block C. The CB segmentation 1106 may be performed to divide the transport block without depending on areas obtained through area division, but may be performed to divide the transport block into C sub-code blocks according to any specified rule. FIG. 11 shows an example of the sub-code block 1 and the sub-code block C obtained through segmentation (division). Codeword area interleaving 1109 is performed on the sub-code block 1 and the sub-code block C, and the area division is performed in a process of the codeword area interleaving 1109. The area division is performed to divide a time-frequency resource of a first terminal device into areas based on overlapping, and the areas obtained through division may include an overlapping area and a non-overlapping area. Herein, an example in which an area 1 and an area N are obtained through division is used. Corresponding to the area 1, a NOMA scheme 1110 corresponding to the area 1, layer mapping 1112, precoding 1114 corresponding to the area 1, and other processing are performed separately, and then, area resource mapping 1116 is performed. Corresponding to the area N, a NOMA scheme 1111 corresponding to the area N, layer mapping 1113, precoding 1115 corresponding to the area N, and other processing are performed separately, and then, the area resource mapping 1116 is performed. In this process, after the codeword area interleaving, each area has a corresponding NOMA scheme, layer mapping and area precoding are separately performed in a subsequent phase, and then the area resource mapping 1116 is performed. The area resource mapping 1116 uses a local mapping rule to perform symbol-to-resource mapping. In other words, mapping rules in different areas are independent of each other, and a mapping rule in an area may be independently designed.

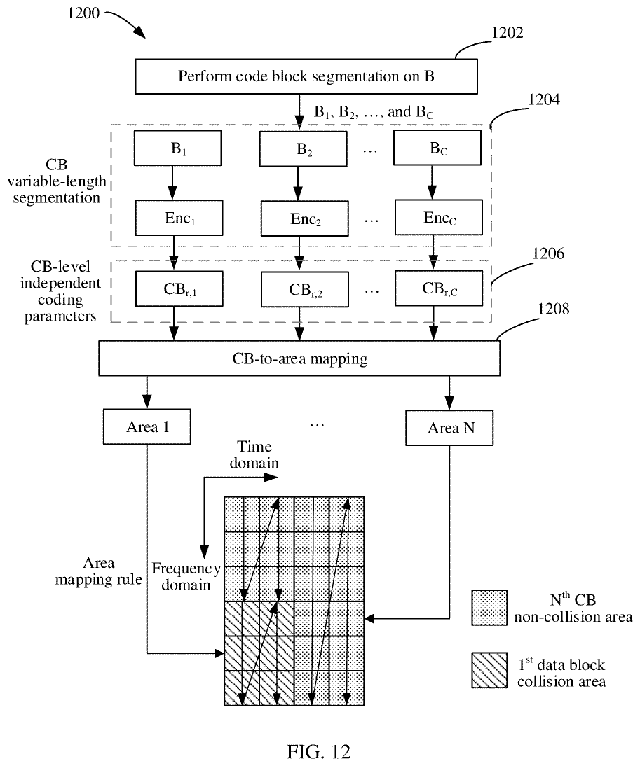

However, different from the transmission scheme adjustment based on the idea of interference impact limitation, in the transmission scheme adjustment based on the idea of interference randomization, all CBs jointly subject to coding in a collision area, in other words, some encoded bits in each CB are mapped to the collision area. Data obtained by encoding different CBs is interleaved and mapped to different areas. There are encoded bits of at least one CB in a same collision area. In this case, a procedure may be shown in FIG. 12. FIG. 12 is a diagram of a communication procedure according to some embodiments. Code block segmentation is performed on a transport block B in the procedure 1200. As shown in a block 1204, C sub-code blocks B₁, B₂, . . . , and B_{C} are obtained, where Bᵢ≥max(Kₘᵢₙ, N_{info, i}), mod(Bᵢ, 8)=0, Σᵢ₌₁^{C}Bᵢ=B, and B₁≤B₂≤. . . ≤B_{C}. C pieces of encoded data Enc₁, Enc₂, . . . , and Enc_{C} are obtained through encoding. The CB segmentation may be CB variable-length segmentation. In some embodiments, the CB segmentation in this step may not require that each sub-CB cover one collision area or one non-collision area, provided that the TB is divided into a plurality of sub-code blocks. Independent coding parameters are set for different sub-code blocks respectively. As shown in a block 1206, C sub-code blocks correspond to parameters CB_{r,1}, CB_{r,2}, . . . , and CB_{r,C} respectively. In a block 1208, CB-to-area mapping is performed. For an area mapping rule, refer to descriptions of the mapping rule in the transmission scheme adjustment based on the idea of interference impact limitation.

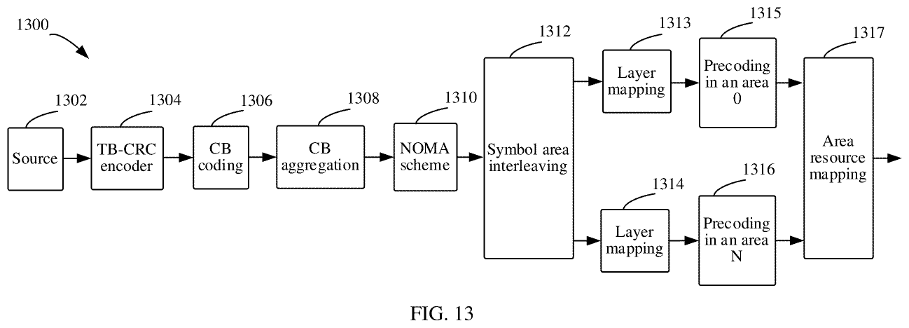

The fifth embodiment corresponds to the transmission scheme based on the independent adjustment of the NOMA scheme and related parameters when the random interleaving manner is introduced. Similar to the fourth embodiment, the NOMA scheme may also reduce the impact of the GF by randomizing interference. The NOMA can use a group of resources to carry information about a plurality of users. The resources in the resource group are associated with each other and share all the information about the users. A NOMA resource mapping area is extended to a wider time-frequency resource space by using a symbol-level interleaving mechanism. This helps a NOMA user resist area-based interference. In some embodiments, in this case, the NOMA scheme may be performed without depending on area division, but the area division is performed in a process of performing symbol area interleaving. In some other embodiments, the NOMA scheme may be performed in each area based on area division, and then overall interleaving is performed based on data processed by using each NOMA scheme. For a block diagram of data sending of a GB user equipment according to an embodiment, refer to a diagram of interleaving-based transmission scheme adjustment shown in FIG. 13 according to some other embodiments. As shown in FIG. 13, in the block diagram 1300 of data sending, after data from a source 1302 is encoded by a TB-CRC encoder 1304, the data is subjected to CB coding 1306, CB aggregation 1308, a NOMA scheme 1310, and other processing, and then symbol area interleaving 1312 is performed. In the symbol area interleaving 1312 step, area division is further performed after the interleaving. The area division is performed to divide a time-frequency resource of a first terminal device into areas based on overlapping, and the areas obtained through division may include an overlapping area and a non-overlapping area. Then, operations such as layer mapping and precoding are performed separately based on the areas obtained through division. For example, the areas obtained through division are an area 0 and an area N. Corresponding to the area 0, layer mapping 1313 is performed, precoding 1315 corresponding to the area 0 is performed, and then, area resource mapping 1317 is performed. Corresponding to the area N, layer mapping 1314 is performed, precoding 1316 corresponding to the area N is performed, and then the area resource mapping 1317 is performed (refer to related descriptions of the area resource mapping in the foregoing embodiments).

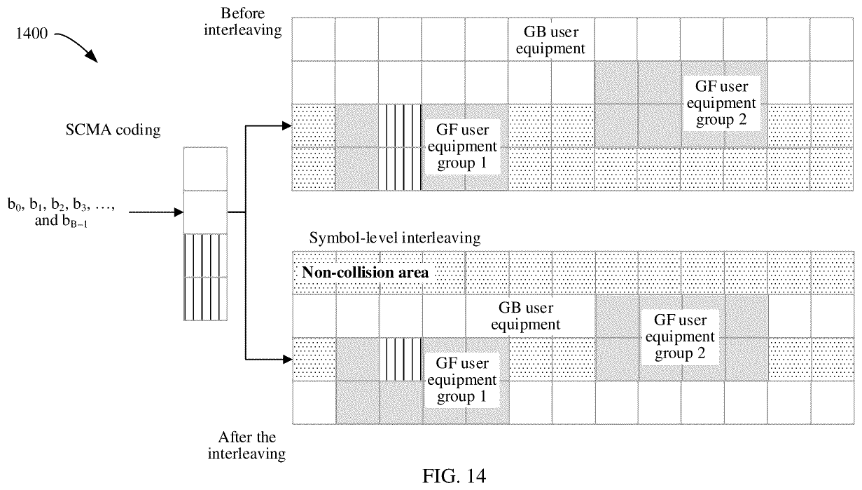

An SCMA scheme is used as an example. Interference changes obviously after the interleaving. FIG. 14 is a corresponding diagram of interference distribution before and after the interleaving. A gray grid is a time-frequency resource area corresponding to a GF user equipment group, a white grid is a time-frequency resource area corresponding to a GB user equipment, a dot pattern grid is a non-collision area, and a stripe pattern grid represents interference. It can be understood from FIG. 14 that in interference distribution comparison 1400 before and after the interleaving, after the interleaving, more SCMA resources jointly resist interference from a GF user equipment, and two pieces of interference (shown in the stripe pattern grids) are dispersed through the interleaving.

For an area mapping rule, refer to descriptions of the mapping rule in the transmission scheme adjustment based on the idea of interference impact limitation. Area-based mapping is implemented by adjusting the mapping rule, to ensure that area interference can be evenly distributed to each adjustment point.

The transmission scheme adjustment is described in the first embodiment to the fifth embodiment, and a transmission scheme obtained through adjustment based on the foregoing method is Trans2. The base station may deliver Trans2 to a GB UE (the GB user equipment) by using DCI signaling. The GB UE parses the DCI signaling and implements Trans2.

On a user equipment side, in some embodiments, the GB user equipment receives the DCI signaling carrying the transmission scheme, and adjusts transmission schemes of different areas based on a signaling indication. The UE receives signaling carrying an initial transmission scheme Trans1 and the adjusted transmission scheme Trans2, and uses different transmission schemes for different areas after parsing the signaling, to reduce interference impact of the GF user equipment and maximize transmission efficiency of a collision area.

A plurality of transmission schemes in embodiments may be carried in same signaling and delivered by a base station to the GB user equipment, or may be carried in different signaling and delivered by a base station to the GB user equipment. Signaling delivering is flexible and diversified, so that requirements of a plurality of scenarios can be met.

The GB user equipment may reduce, by adjusting transmission schemes (in a codeword level, a NOMA symbol level, and the like) of different areas, the interference from the GF user equipment to the GB user equipment when the GF user equipment sends data. When the GF user equipment does not send data, the GB user equipment can maximize the transmission efficiency of the collision area.

In some embodiments, specific transmission schemes and related parameters of the initial transmission scheme Trans1 and the adjusted transmission scheme Trans2 are different. There may be a plurality of adjusted transmission schemes Trans2, and the adjusted transmission schemes Trans2 correspond to different time-frequency resource areas respectively. The initial transmission scheme Trans1 may be considered as a default transmission scheme, and is used in the non-collision area. The adjusted transmission scheme Trans2 may be applied in the collision area, and Trans2 may vary in different collision areas. In this manner, an objective of minimizing the interference impact of the GF user equipment on the GB user equipment can be achieved.

In some embodiments, which are referred to as a sixth embodiment herein, a scheme in this embodiment is used to process a scenario in which a GF user equipment preempts a time-frequency resource. A gNB adds a transmission scheme Trans2 of the GB user equipment in the collision area based on burst preemption information of the GF user equipment, and delivers the transmission scheme Trans2 to the GB user equipment. Before this scenario occurs, the base station has determined Trans1 and Trans2 (if any) of the GB user based on existing GB scheduling information and GF/GB collision information, and has delivered Trans1 and Trans2 to the GB UE by using signaling. The (group of) signaling is defined as signaling 1. For a specific procedure, refer to the first embodiment to the fifth embodiment. Then, the base station enters a GF/GB user equipment time-frequency resource collision detection mode, and prepares to update the Trans2 transmission scheme at any time based on a change and deliver an updated Trans2 transmission scheme to the GB user equipment.

The GB UE parses the DCI signaling delivered by the base station, determines Trans2 transmission schemes of different areas, and then enters a monitoring mode to monitor whether there is new DCI signaling of the Trans2 transmission scheme.

When a new time-frequency resource collision occurs, the base station updates the area division first. The area division may be performed again, or existing collision areas may be adjusted or combined to update the area division. After area update is completed, the base station updates the Trans2 scheme, the Trans1 scheme, and corresponding parameters according to an area, an interference handling criterion, and transmission scheme adjustment. If an interference-limited criterion is used, for an updated scheme, refer to the first embodiment to the third embodiment. If an idea of interference randomization is used, for an updated scheme, refer to the fourth embodiment and the fifth embodiment.

After the update is completed, the base station sends updated Trans1 and Trans2 to the GB UE by using the DCI signaling.

In some other embodiments, which are referred to as a seventh embodiment herein, a scheme in this embodiment is used in a scenario in which transmission of the GF user equipment is canceled and the GF/GB collision ends. In this case, the base station cancels the Trans2(i) transmission scheme in the collision area and delivers cancellation signaling to the GB user equipment. In some embodiments, there may be a plurality of reasons for canceling the transmission of the GF user equipment. For example, subsequent transmission is canceled because repetition transmission is correct, or after the transmission of the GF user equipment fails for a plurality of times, the transmission of the GF user equipment is converted to scheduling transmission of the GB user equipment. In this case, the base station may obtain information indicating that the GF user equipment exits from occupying the time-frequency resource, and may deliver signaling to the GB user equipment, to cancel the transmission scheme for the area corresponding to the GB user equipment.

Before this, the base station has completed configuration (Trans2(i), Trans1) of a transmission scheme of the GB user equipment, and has delivered the configuration to the GB user equipment by using the signaling 1. The GB user equipment has also configured, based on the signaling 1, transmission schemes corresponding to different areas. Then, the base station enters a detection period, to detect a change of the GF/GB user equipment resource collision.

When the GB UE waits for sending, if transmission of the GF user equipment in a corresponding collision area i is canceled, and the GF/GB user equipment time-frequency resource collision no longer occurs, Trans2(i) is invalid, and the transmission scheme of the GB UE is restored to the default initial transmission scheme Trans1. For an indication of the base station indicating that Trans2(i) of the GB user equipment is invalid, the base station only needs to deliver an instruction indicating that Trans2(i) is invalid (position information is carried in previous signaling). The signaling is defined as signaling 3, and is carried in DCI and delivered to the GB user equipment. Based on the transmission scheme Trans2(i) being canceled by using signaling, it is ensured that the interference impact of the GF user equipment on the GB user equipment is minimized.

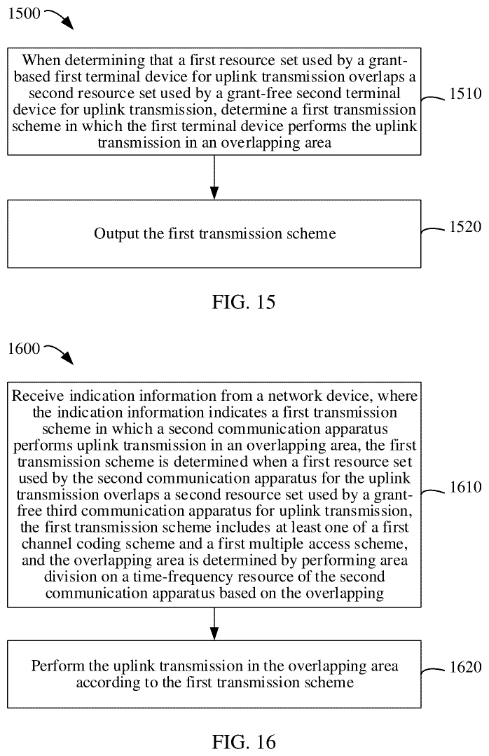

FIG. 15 is a diagram of a procedure implemented at a first communication apparatus 201 according to some embodiments. As shown in FIG. 15, the procedure 1500 implemented at the first communication apparatus 201 includes: when the first communication apparatus 201 determines that a first resource set used by a grant-based first terminal device 110 for uplink transmission overlaps a second resource set used by a grant-free second terminal device 120 for uplink transmission, the first communication apparatus 201 determines a first transmission scheme in which the first terminal device 110 performs the uplink transmission in an overlapping area (1510). The first transmission scheme includes at least one of a first channel coding scheme and a first multiple access scheme, and the overlapping area is determined by performing area division on a time-frequency resource of the first terminal device 110 based on the overlapping. The first communication apparatus 201 outputs the first transmission scheme (1520).

FIG. 16 is a diagram of a procedure implemented at a grant-based second communication apparatus 202 according to some embodiments. As shown in FIG. 16, the procedure 1600 implemented at the second communication apparatus 202 includes: the grant-based second communication apparatus 202 receives indication information from a network device 130 (1610). The indication information indicates a first transmission scheme in which the second communication apparatus 202 performs uplink transmission in an overlapping area, the first transmission scheme is determined when a first resource set used by the second communication apparatus 202 for the uplink transmission overlaps a second resource set used by a grant-free third communication apparatus for uplink transmission, the first transmission scheme includes at least one of a first channel coding scheme and a first multiple access scheme, and the overlapping area is determined by performing area division on a time-frequency resource of the second communication apparatus 202 based on the overlapping. The second communication apparatus 202 performs the uplink transmission (1620) in the overlapping area according to the first transmission scheme.

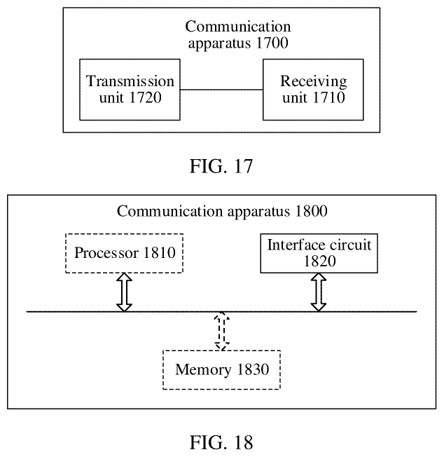

FIG. 17 is a diagram of main composition of a possible communication apparatus according to an embodiment. These communication apparatuses may implement functions of the first communication apparatus 201 or the second communication apparatus 202 in the foregoing method embodiments, and therefore can also achieve at least the beneficial effects of the foregoing method embodiments. In this embodiment, for the terminal device 110 that is shown in FIG. 1 and that is used as an example of the second communication apparatus 202, the communication apparatus may be, for example, the first terminal device 110, or may be a module (for example, a chip) used in the first terminal device 110.

An example in which the communication apparatus implements the function of the second communication apparatus 202 is used. As shown in FIG. 17, the communication apparatus 1700 includes a receiving unit 1710 and a transmission unit 1720. The communication apparatus may be configured to implement the function of the second communication apparatus 202 in the method embodiment shown in FIG. 16 or the second communication apparatus 202 (the first terminal device 110) shown in FIG. 2A. In some embodiments, the transmission unit 1720 may be a transmitter, and the receiving unit 1710 may be a receiver.

When the communication apparatus 1700 is configured to implement the function of the second communication apparatus 202 (the first terminal device 110) in the method embodiment shown in FIG. 2A, the receiving unit 1710 is configured to receive indication information from a network device 130, where the indication information indicates a first transmission scheme in which the grant-based second communication apparatus 202 performs uplink transmission in an overlapping area, the first transmission scheme is determined when a first resource set used by the second communication apparatus 202 for the uplink transmission overlaps a second resource set used by a grant-free third communication apparatus for uplink transmission, the first transmission scheme includes at least one of a first channel coding scheme and a first multiple access scheme, and the overlapping area is determined by performing area division on a time-frequency resource of the second communication apparatus 202 based on the overlapping; and the transmission unit 1720 is configured to perform the uplink transmission in the overlapping area according to the first transmission scheme.

A case in which the communication apparatus implements the function of the first communication apparatus 201 is similar to the foregoing descriptions, and is not described. In addition, for more detailed descriptions of the receiving unit 1710 and the transmission unit 1720, refer to related descriptions in the foregoing method embodiments. Details are not described herein again.

As shown in FIG. 18, a communication apparatus 1800 includes an interface circuit 1820. Optionally, the communication apparatus 1800 may further include a processor 1810. The processor 1810 and the interface circuit 1820 are coupled to each other. It may be understood that the interface circuit 1820 may be a transceiver or an input/output interface. Optionally, the communication apparatus 1800 may further include a memory 1830, configured to store instructions executed by the processor 1810, store input data needed by the processor 1810 to run instructions, or store data generated after the processor 1810 runs instructions.

When the communication apparatus 1800 is configured to implement the method in the method embodiment in FIG. 16, the interface circuit 1820 is configured to perform a function of the receiving unit 1710 or the transmission unit 1720.

When the communication apparatus is a chip used in the terminal device 110 (the first terminal device 110), the chip in the terminal device implements a function of the terminal device 110 in the foregoing method embodiments. The chip in the terminal device receives information from another module (for example, a radio frequency module or an antenna) in the terminal device 110, where the information may be sent by another terminal device 110. Alternatively, the chip in the terminal device sends information to another module (for example, a radio frequency module or an antenna) in the terminal device 110, where the information is sent to another terminal device 110.

It may be understood that, the processor in embodiments may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any regular processor or the like.

An embodiment provides a communication system. The communication system may include the communication apparatus in the embodiment shown in FIG. 17, for example, the terminal device 110 or 120. Optionally, the terminal device 110 or 120 in the communication system may perform the communication method shown in FIG. 16. In some other embodiments, the communication system may include a communication apparatus that may perform the communication method shown in FIG. 15, for example, the network device 130.

An embodiment further provides a circuit. The circuit may be coupled to a memory, and may be configured to perform a procedure related to the terminal device 110 or 120, or the network device 130 in any one of the foregoing method embodiments. A chip system may include a chip, and may further include another component like a memory or a transceiver.

It should be understood that the processor mentioned in embodiments may be a CPU, or may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

It may be understood that the memory mentioned in embodiments may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of example, and not limitation, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), and a direct rambus dynamic random access memory (DR RAM).

It should be noted that when the processor is a general-purpose processor, a DSP, an ASIC, an FPGA or another programmable logic device, a discrete gate, a transistor logic device, or a discrete hardware component, the memory (a storage module) is integrated into the processor.

It should be noted that the memory described herein includes, but is not limited to, these memories and any memory of another proper type.

It should be understood that sequence numbers of the foregoing processes do not mean execution sequences in various embodiments. The execution sequences of the processes should be determined according to functions and internal logic of the processes, and should not be construed as any limitation on the implementation processes of embodiments.

A person of ordinary skill in the art may be aware that, in combination with the examples described in embodiments, modules and algorithm steps may be implemented by electronic hardware or a combination of computer software and electronic hardware. Whether the functions are performed by hardware or software depends on particular applications and design constraint conditions of the solutions. A person skilled in the art may use different methods to implement the described functions for each particular application, but it should not be considered that the implementation goes beyond the scope of the embodiments.

It may be clearly understood by a person skilled in the art that, for the purpose of convenient and brief description, for a detailed working process of the foregoing system, apparatus, and module, refer to a corresponding process in the foregoing method embodiments, and details are not described herein again.

In several embodiments provided, it should be understood that the communication method and apparatus may be implemented in other manners. For example, the described apparatus embodiment is merely an example. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The modules described as separate parts may or may not be physically separate, and parts displayed as modules may or may not be physical modules, may be located in one position, or may be distributed on a plurality of network units. A part or all of the units may be selected based on an actual need to achieve the objectives of the solutions of embodiments.

In addition, function modules in embodiments may be integrated into one processing module, or each of the modules may exist alone physically, or two or more modules are integrated into one module.

When the functions are implemented in the form of a software function module and sold or used as an independent product, the functions may be stored in a non-transitory computer-readable storage medium. Based on such an understanding, the solutions in the embodiments essentially, or the part making contributions, or a part of the solutions may be implemented in a form of a software product. The computer software product is stored in a storage medium and includes several instructions for instructing a computer device (which may be a personal computer, a server, a network device 130, or the like) to perform all or a part of steps of the methods described in embodiments. The non-transitory computer-readable storage medium may be any usable medium that can be accessed by a computer. For example, the computer-readable medium may include, but is not limited to: a random access memory (RAM), a read-only memory (ROM), an electrically erasable programmable read-only memory (EEPROM), a compact disc read-only memory (CD-ROM), a universal serial bus flash disk, a removable hard disk, or another optical disc storage or a disk storage medium, or another magnetic storage device, or any other medium that can carry or store expected program code in a form of an instruction or a data structure and that can be accessed by a computer.

As used herein, the term “include” and similar terms should be understood as open inclusion, that is, “include, but not limited to”. The term “based on” should be understood as “at least partially based on”. The term “one embodiment” or “this embodiment” should be understood as “at least one embodiment”. Terms such as “first”, “second”, and the like may refer to different objects or a same object, and are merely used to distinguish between specified objects, but do not imply a specific spatial order, a time order, an importance order, or the like of the specified objects. In some embodiments, a value, a process, a selected item, a determined item, a device, an apparatus, a means, a part, a component, or the like is referred to as “optimal”, “lowest”, “highest”, “minimum”, “maximum”, or the like. It should be understood that such a description is intended to indicate that a selection may be made among many available functional selections, and that such a selection does not need to be better, lower, higher, smaller, larger, or otherwise preferred than other selections in other aspects or in all aspects. As used herein, the term “determining” may cover a variety of actions. For example, “determining” may include operating, calculation, processing, export, investigation, lookup (for example, lookup in a table, database, or another data structure), finding, and the like. In addition, “determining” may include receiving (for example, receiving information), accessing (for example, accessing data in a memory), and the like. In addition, “determining” may include parsing, selection, choice, establishment, and the like.

The foregoing descriptions are merely specific implementations of the embodiments, and are not intended to limit their scope. Any variation or replacement that a person skilled in the art shall fall within the scope of the embodiments.

1. A communication method, comprising:
receiving, by a grant-based second communication apparatus, indication information from a network device, wherein the indication information indicates a first transmission scheme in which the second communication apparatus performs uplink transmission in an overlapping area, the first transmission scheme is determined when a first resource set used by the second communication apparatus for the uplink transmission overlaps a second resource set used by a grant-free third communication apparatus for uplink transmission, the first transmission scheme comprises at least one of a first channel coding scheme or a first multiple access scheme, and the overlapping area is determined by performing area division on a time-frequency resource of the second communication apparatus based on the overlapping; and
performing, by the second communication apparatus, the uplink transmission in the overlapping area according to the first transmission scheme.

2. The method according to claim 1, wherein the first transmission scheme comprises a channel coding scheme and related parameters corresponding to a sub-code block in the overlapping area, and the sub-code block is obtained by dividing a transport block of the second communication apparatus based on the area division.

3. The method according to claim 2, wherein the channel coding scheme and related parameters corresponding to the sub-code block in the overlapping area comprise at least one of the following:
a new code block length that is of the sub-code block in the overlapping area and that is less than a preset code block length;
a new code rate that is of the sub-code block in the overlapping area and that is lower than a preset code rate; or
a channel coding method that matches a size of data that can be carried in the overlapping area.

4. The method according to claim 1, wherein the first transmission scheme comprises:
a multiple access scheme and related parameters corresponding to the overlapping area.

5. The method according to claim 4, wherein the multiple access scheme and related parameters corresponding to the overlapping area are determined by performing at least one of the following operations:
lowering a modulation order;
limiting a transmission signal; or
adjusting the multiple access scheme.

6. The method according to claim 1, wherein the first transmission scheme further comprises an interleaving scheme, and the interleaving scheme comprises one of the following:
interleaving data encoded by using the first channel coding scheme, wherein interleaved data corresponding to the same overlapping area comprises encoded data corresponding to at least one sub-code block, and the sub-code block is obtained by dividing the transport block of the second communication apparatus; or
interleaving data processed by using the first multiple access scheme, wherein interleaved data corresponding to the same overlapping area comprises processed data corresponding to at least one sub-data sequence, and the sub-data sequence is obtained by dividing data processed by the second communication apparatus by using the first multiple access scheme.

7. The method according to claim 1, wherein the first transmission scheme further comprises a symbol-to-resource mapping rule corresponding to the overlapping area, and the mapping rule corresponding to the overlapping area and a mapping rule corresponding to an area other than the overlapping area are independent of each other.

8. The method according to claim 1, wherein the overlapping area is determined based on at least one of the following:
a time-frequency position of the second resource set and a constraint related to a channel coding scheme; or
a time-frequency position of the second resource set and a constraint related to a multiple access scheme.

9. The method according to claim 1, further comprising:
before performing the uplink transmission, receiving, by the second communication apparatus from the network device, an updated first transmission scheme and indication information of a corresponding updated overlapping area; and
performing, by the second communication apparatus, the uplink transmission in the updated overlapping area according to the updated first transmission scheme.

10. The method according to claim 1, further comprising:
before performing the uplink transmission, receiving, by the second communication apparatus from the network device, indication information indicating that the first transmission scheme is invalid; and
performing, by the second communication apparatus, the uplink transmission in the overlapping area by using a second transmission scheme, wherein the second transmission scheme is a transmission scheme that is determined by the network device when it is assumed that the overlapping does not exist and in which the second communication apparatus performs the uplink transmission, and the indication information further indicates the second transmission scheme.

11. The method according to claim 10, wherein the second communication apparatus receives the indication information from the network device by using signaling, and the signaling comprises at least one of the following:
a length of the transport block of the second communication apparatus;
a transmission scheme type, wherein the type indicates at least one of the following:
different first transmission schemes or different second transmission schemes, wherein first transmission schemes indicated by different types have different content;
a transmission scheme quantity;
transmission scheme content; or
a time-frequency resource position of the second communication apparatus.

12. A communication method, comprising:
when a first communication apparatus determines that a first resource set used by a grant-based first terminal device for uplink transmission overlaps a second resource set used by a grant-free second terminal device for uplink transmission, determining, by the first communication apparatus, a first transmission scheme in which the first terminal device performs the uplink transmission in an overlapping area, wherein the first transmission scheme comprises at least one of a first channel coding scheme or a first multiple access scheme, and the overlapping area is determined by performing area division on a time-frequency resource of the first terminal device based on the overlapping; and
outputting, by the first communication apparatus, the first transmission scheme.

13. The method according to claim 12, wherein determining the first transmission scheme comprises:
dividing, by the first communication apparatus, a transport block of the first terminal device into a sub-code block based on the area division; and
determining, by the first communication apparatus, a channel coding scheme and related parameters corresponding to the sub-code block in the overlapping area.

14. The method according to claim 13, wherein determining the channel coding scheme and related parameters corresponding to the sub-code block in the overlapping area comprises at least one of the following:
reducing, by the first communication apparatus, a code block length of the sub-code block in the overlapping area;
lowering, by the first communication apparatus, a code rate of the sub-code block in the overlapping area; and
using, by the first communication apparatus, a channel coding method that matches a size of data that can be carried in the overlapping area.

15. The method according to claim 12, wherein determining the first transmission scheme comprises:
determining, by the first communication apparatus, a multiple access scheme and related parameters corresponding to the overlapping area.

16. The method according to claim 15, wherein determining the multiple access scheme and related parameters comprises:
based on the first terminal device and the second terminal device both using orthogonal multiple access in the overlapping area, adjusting, by the first communication apparatus, a parameter of the multiple access scheme by performing at least one of the following operations: lowering a modulation order or limiting a transmission signal.

17. The method according to claim 15, wherein determining the multiple access scheme and related parameters comprises:
based on the first terminal device using orthogonal multiple access and the second terminal device using non-orthogonal multiple access in the overlapping area, switching, by the first communication apparatus, a multiple access scheme of the first terminal device to a non-orthogonal multiple access scheme; or
based on the first terminal device and the second terminal device both using non-orthogonal multiple access in the overlapping area, determining, by the first communication apparatus, that the first terminal device keeps a non-orthogonal multiple access scheme, wherein
in the non-orthogonal multiple access scheme that is switched to or kept, the first communication apparatus indicates the first terminal device to select a parameter of the multiple access scheme based on interference from the second terminal device.

18. The method according to claim 12, wherein the first transmission scheme further comprises an interleaving scheme, and the interleaving scheme comprises at least one of the following:
interleaving data encoded by using the first channel coding scheme, wherein interleaved data corresponding to the same overlapping area comprises encoded data corresponding to at least one sub-code block, and the sub-code block is obtained by dividing the transport block of the first terminal device; or
interleaving data processed by using the first multiple access scheme, wherein interleaved data corresponding to the same overlapping area comprises processed data corresponding to at least one sub-data sequence, and the sub-data sequence is obtained by dividing data processed by the first terminal device by using the first multiple access scheme.

19. The method according to claim 1, wherein the first transmission scheme further comprises a symbol-to-resource mapping rule corresponding to the overlapping area.

20. A non-transitory computer-readable storage medium, wherein storage medium coupled to one or more processors and storing programming instructions for execution by the one or more processors, the programming instructions instruct the processor to:
receiving indication information from a network device, wherein the indication information indicates a first transmission scheme in which the second communication apparatus performs uplink transmission in an overlapping area, the first transmission scheme is determined when a first resource set used by the second communication apparatus for the uplink transmission overlaps a second resource set used by a grant-free third communication apparatus for uplink transmission, the first transmission scheme comprises at least one of a first channel coding scheme or a first multiple access scheme, and the overlapping area is determined by performing area division on a time-frequency resource of the second communication apparatus based on the overlapping; and
performing the uplink transmission in the overlapping area according to the first transmission scheme.
